(19) United States
(12) Patent Application Publication
(10) Pub. No.: US 2025/0388804 A1
(43) Pub. Date: Dec. 25, 2025

(54) Acidizing Fluid with Foam Stabilizing Agent Comprising Antimony Compound

(71) Applicant: Halliburton Energy Services, Inc., Houston, TX (US)

(72) Inventors: Scott Thomas Squires, Houston, TX (US); Aaron M. Beuterbaugh, Houston, TX (US)

(21) Appl. No.: 18/753,693

(22) Filed: Jun. 25, 2024

(51) Int. Cl. C09K 8/74

(52) U.S. Cl. CPC C09K 8/74; C09K 2208/30

(57) ABSTRACT

An acidizing fluid, such as for matrix acidizing or fracture-acidizing a subterranean zone, the acidizing treatment fluid comprising: an acid; an aqueous base fluid; a gelling agent; and a foaming stabilizing agent, wherein the foaming stabilizing agent comprises an antimony-containing compound. The acidizing fluid can further include a foaming agent. Methods of making and utilizing the acidizing fluid are also provided.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present disclosure generally relates to acidizing subterranean formations, and, more specifically, to methods for acidizing subterranean formations in the presence of an acidizing fluid including a foaming stabilizing agent comprising an antimony-containing compound.

Treatment fluids can be used in a variety of subterranean treatment operations. Such treatment operations can include, without limitation, drilling operations, stimulation operations, production operations, remediation operations, sand control treatments, and the like. More specific examples of illustrative treatment operations can include drilling operations, fracturing operations, gravel packing operations, acidizing operations, scale dissolution and removal operations, sand control operations, consolidation operations, and the like.

Acidizing operations may be used to stimulate a subterranean formation to increase production of a hydrocarbon resource therefrom. Introduction of the acidizing fluid to the subterranean formation may take place at matrix flow rates without fracturing of the formation matrix, or at higher injection rates and pressures to fracture the formation (e.g., an acid-fracturing operation). During an acidizing operation, an acid-soluble material in the subterranean formation can be dissolved by one or more acids to expand existing flow pathways in the subterranean formation, to create new flow pathways in the subterranean formation, and/or to remove acid soluble precipitation damage in the subterranean formation. The acid-soluble material being dissolved by the acid(s) can be part of or formed from the native formation matrix or can have been deliberately introduced into the subterranean formation in conjunction with a stimulation or like treatment operation (e.g., proppant or gravel particulates). Illustrative substances within the native formation matrix that may be dissolved by an acid include, but are not limited to, carbonates, silicates and aluminosilicates. Other substances can also be dissolved during the course of performing an acidizing operation, and the foregoing substances should not be considered to limit the scope of substances that may undergo acidization.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustrative schematic of a system that can deliver acidizing treatment fluids of the present disclosure to a downhole location according to embodiments of the disclosure; and

FIG. 2 shows a picture of a beaker containing a foamed acidizing fluid of this disclosure on the left, and a beaker containing a comparative acidizing fluid absent the foaming stabilizing agent of this disclosure on the right.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

It should be noted that when “about” is used herein at the beginning of a numerical list, “about” modifies each number of the numerical list. Further, in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, particle sizes, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the illustrative embodiments described herein. At the very least, and not as an attempt to limit the application of the doctrine of equivalents to the scope of the claim, each numerical parameter should at least be construed in light of the number of reported significant digits and by applying ordinary rounding techniques. The term “about” as used herein can thus allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid or a component thereof, unless otherwise specified herein.

As used herein, the term “treatment fluid” refers generally to any fluid that may be used in a subterranean application in conjunction with a desired function and/or for a desired purpose. The term “treatment fluid” does not imply any particular action by the fluid or any component thereof. As used herein, the term “particulate-laden treatment fluid” is a treatment fluid that comprises particulates such as proppant, gravel, fluid loss and/or diverting agents.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “fluid” refers to liquids and gels, unless otherwise indicated.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

The term “crosslinking agent” as used herein is defined to include any substance that is capable of promoting or regulating intermolecular bonding between polymer chains, linking them together to create a more rigid structure.

As used herein, the term “clarified” in reference to a gelling agent refers to a gelling agent that has improved turbidity and/or filtration properties as compared to nonclarified gelling agent. For example, as used herein, the term “clarified diutan” as used herein can refer to a diutan that has improved turbidity and/or filtration properties as compared to nonclarified diutan. The term “clarified xanthan” can refer to a xanthan that has a flow rate of at least about 200 mL in 2 minutes at ambient temperature in a filtering laboratory test on a Baroid Filter Press using 40 psi of differential pressure and a 9 cm Whatman filter paper having a 2.7 m pore size.

As used herein, the term “fracture gradient” may refer to the pressure required to induce one or more fractures in rock at a given depth. A person of ordinary skill in the art with the benefit of this disclosure would be capable of determining the fracture gradient of a given formation.

The term “solvent” as used herein refers to a liquid that can dissolve a solid, liquid, or gas. Nonlimiting examples of solvents are silicones, organic compounds, water, alcohols, ionic liquids, and supercritical fluids.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

If there is any conflict in the usages of a word or term in this specification and one or more patent or other documents that may be incorporated herein by reference, the definitions that are consistent with this specification should be adopted.

The present disclosure generally relates to acidizing subterranean formations, and, more specifically, to methods for acidizing subterranean formations in the presence of acidic treatment fluids (“acidizing fluids”) used in industrial and oil field operations, and relates still more particularly, to acidic treatment fluids including a foaming stabilizing agent comprising, consisting essentially of, or consisting of an antimony-containing compound, and the use thereof in industrial and oil field operations. The present disclosure thus provides acidic treatment fluids used in industrial and oil field operations, the acidizing fluids comprising foaming stabilizing agents comprising antimony-containing compound, and their use in industrial and oil field operations. Such operations may involve the removal of scale, fracture acidizing, matrix acidizing, diversion, filter cake removal, perforation cleanout, or pill removal.

Acidizing and fracturing procedures using acidic treatment fluids are commonly carried out in subterranean well formations to accomplish a number of purposes including, but not limited to, facilitation of desirable hydrocarbon recovery from the formation. One commonly used aqueous acidic treatment fluid comprises hydrochloric acid. Other commonly used acids for acidic treatment fluids include: hydrofluoric acid, acetic acid, formic acid, citric acid, ethylene diamine tetra acetic acid (“EDTA”), glycolic acid, sulfamic acid, N-phosphonoalkyl aminocarboxylic acid, and derivatives or combinations thereof. Acidic treatment fluids are used in various subterranean operations. For example, formation acidizing or “acidizing” is a method for increasing the flow of desirable hydrocarbons from a subterranean formation. In a matrix acidizing procedure, an aqueous acidic treatment fluid can be introduced into a subterranean formation via a wellbore therein under fracturing pressure so that the acidic treatment fluid flows into the pore spaces (matrix) of the formation and reacts with the acid-soluble materials therein. As a result, the pore spaces of that portion of the formation are enlarged, and consequently, the permeability of the formation can increase. The flow of hydrocarbons from the formation can thus be increased because of the increase in formation conductivity or permeability caused, inter alia, by dissolution of the formation material. In fracture acidizing procedures, one or more fractures are produced in the formations and an acidic treatment fluid is introduced into the fracture(s) to etch the fracture face therein. Acidic treatment fluids also may be used to clean out wellbores to facilitate the flow of desirable hydrocarbons. Other acidic treatment fluids may be used in diversion processes, and wellbore clean-out processes. A specific example is filter cake removal.

The present disclosure provides improved (e.g., foamed) acidizing fluids for acidizing or fracture-acidizing subterranean zones, improved acidizing fluid foaming stabilizing agents, and improved methods of acidizing subterranean zones. The herein disclosed acidizing fluids generally comprise an acid and an aqueous base fluid (also referred to as an “aqueous carrier fluid”), a gelling agent, and an effective amount of a foaming stabilizing agent (e.g., for foaming and stabilizing the gelled aqueous acid solution). The acidizing fluid be foamed, and the foamed acidizing fluid can further include a foaming agent (e.g., a surfactant and/or sufficient gas to form a foam), as described hereinbelow. The foaming stabilizing agent of this disclosure comprises, consists essentially of, or consists of an antimony-containing compound.

In embodiments, the acidizing fluid comprises from about 2.5 to about 37, from about 5 to about 35 or from about 1 to about 35 weight percent (wt %) of the acid; from about 0.5 to about 98, from about 1 to about 90, or from about 5 to about 85 wt % of the aqueous base fluid; from about 0.1 to about 10, from about 0.5 to about 10, or from about 1 to about 5 wt % of the gelling agent; from about 0.1 to about 10, from about 0.5 to about 10, or from about 0.5 to about 8 wt % of the foaming agent; and from about 0.1 to about 10, from about 0.5 to about 10, or from about 0.5 to about 8 wt % of the foaming stabilizing agent.

In embodiments, an acidizing fluid of this disclosure comprises from about 2.5 to about 37, from about 5 to about 35 or from about 1 to about 35 weight percent (wt %) of an acid; from about 0.1 to about 10, from about 0.5 to about 10, or from about 1 to about 5 wt % of a gelling agent; from about 0.1 to about 10, from about 0.5 to about 10, or from about 0.5 to about 8 wt % of a foaming agent; from about 0.1 to about 10, from about 0.5 to about 10, or from about 0.5 to about 8 wt % of a foaming stabilizing agent comprising, consisting essentially of, or consisting of an antimony-containing compound; and the balance an aqueous base fluid. The acidizing fluid can be foamed to provide a foamed acidizing fluid comprising the acidizing fluid that has been foamed with a gas and comprising from about 10 to about 90, about 10 to about 80, or about 20 to about 80 wt % of the gas. The foaming agent can include the gas and/or a surfactant, as described further hereinbelow.

The methods of the present disclosure for acidizing or fracture-acidizing subterranean zones penetrated by wellbores can generally comprise the following steps: a foamed acidizing fluid is prepared comprised of an acid and an aqueous base fluid (also referred to wherein as an “aqueous carrier fluid”), a gelling agent, sufficient gas to form a foam and an effective amount of a foaming stabilizing agent for foaming and stabilizing the gelled aqueous acid solution; thereafter, the subterranean zone can be contacted with the foamed acidizing fluid. The acid and the aqueous base fluid can be provided as an aqueous acid solution comprising the acid and the aqueous base fluid. The acidizing fluid can further include a non-gaseous foaming agent (e.g., a surfactant), in embodiments.

As discussed in more detail hereinbelow, foam-stability can be characterized by a half-drain time. A half-drain time is an observed value after mixing of the foamed blend to monitor for drainage (separation) of liquid. The acid can be prepared from a known liquid volume; thus once half of that liquid volume is observed, the blend stability time has been reached. The acidizing fluids of this disclosure can be foamed, and a half drain time of the foamed acidizing fluids of this disclosure can be improved relative to acidizing fluids absent the foaming stabilizing agent.

Conventional acidizing jobs can have a duration of from about 5 to 7 hours or more to completion, and it is common for non-stabilized foam blends to exhibit less than or equal to about ten minutes of stability. Foams displaying about ten minutes of stability may not provide desired performance due to premature collapsing, separation, and/or drainage, all of which can lead to poor fluid qualities and poor zonal coverage which can result in poor job execution.

One of the major causes for loss of foam stability is the inclusion of additives (e.g., corrosion inhibitors, surfactants, anti-sludging agents, gelling agents, etc.) that are detrimental to foam formation or quality. For example, acid corrosion inhibitors, including acid corrosion inhibitors comprising a propargyl based alcohol can have negative effects on foam generation, stability, and compatibility. As described hereinbelow and experimentally illustrated in the Example, it has been unexpectedly discovered that, with the inclusion of a foam stabilizing agent comprising antimony tetraoxide (pyroantimonate), the behavior of the acidizing fluid disclosed herein exhibits improved performance (e.g., exhibits robust foam properties) even in the presence of the aforementioned acid additives detrimental to foam quality in conventional formulations.

Although conventional formulations of stabilized foamed blends can work well in regard to stability time, they can be restricted in terms of regional availability for procuring and sourcing. There are widespread issues with sourcing and procuring of acidizing gelling agents, for example, SGA-HT® acid system gelling agent (comprising cationic acrylamide/dimethylaminoethyl methacrylate methychloride salt and available from Halliburton Energy Services, Inc., of Duncan, OK). Some regions currently have other polymers available (e.g., SGA-II™ acid gelling agent comprising acrylamide/AMPS/acrylic acid terpolymer and available from Halliburton Energy Services, Inc., of Duncan, OK), LX-1M (comprising amphoteric arrylamide) and available from Halliburton Energy Services, Inc., of Duncan, OK), and potentially other similar polymers. Via this disclosure, such regionally available polymers typically not associated with foamed acid applications can be successfully utilized to formulate acidizing fluids that provide foaming efficacy.

Herein disclosed is an acidizing fluid (also referred to herein as an “acidizing treatment fluid”, an “acidic fluid”, an “acidic treatment fluid”, or simply a, “treatment fluid”) comprising an acid, an aqueous fluid (e.g., water), a gelling agent; and a foaming stabilizing agent. The acidizing fluid can further include a foaming agent. As detailed further hereinbelow, the acidizing fluid of this disclosure can provide improved foam stability, improved additive compatibility, improved diversion, improved supply chain logistics, or a combination thereof.

The herein disclosed acidizing fluid comprises a foaming stabilizing agent. The foaming stabilizing agent comprises, consists essentially of, or consists of an antimony-containing compound. Suitable antimony-containing compounds include, without limitation, antimonate salts, antimony oxides, antimony halides, antimony tartrate, antimony citrate, alkali metal salts of antimony tartrate and antimony citrate, alkali metal salts of pyroantimonate and antimony adducts of ethylene glycol, or combinations thereof. In embodiments, the antimony-containing compound comprises antimony tetroxide (Sb₂O₄), antimony trichloride (SbCl₃), or a combination thereof. In embodiments, the antimony-containing compound comprises alpha-Sb₂O₄, beta-Sb₂O₄, or combinations thereof. In an embodiment, the antimony-containing compound comprises (i) HII-500MTM, comprising antimony tetroxide and available from Halliburton Energy Services, Inc., of Duncan, OK; (ii) HII-702™, comprising antimony trichloride and available from Halliburton Energy Services, Inc., of Duncan, OK; or (iii) both (i) and (ii).

Other additional foaming stabilizing agents can be utilized, in embodiments, in addition to the one or more antimony-containing compounds. For example, additional foaming stabilizing agents can include hydrolyzed keratin, as described in U.S. Pat. No. 6,555,505 entitled, “Foamed Acidizing Fluids, Additives and Methods of Acidizing Subterranean Zones”, the disclosure of which is hereby incorporated herein for purposes not contrary to this disclosure. Hydrolyzed keratin can be manufactured by the base hydrolysis of hooves and horn meal by lime in an autoclave to produce a hydrolyzed protein. The protein is commercially available as a free-flowing powder that contains about 85% protein. The non-protein portion of the powder can consist of about 0.58% insoluble material, with the remainder being soluble non-protein materials primarily made up of calcium sulfate, magnesium sulfate and potassium sulfate. Alternatively, in embodiments, no additional foaming stabilizing agents are present in the acidizing fluid in addition to the one or more antimony-containing compounds. Alternatively, in embodiments, the acidizing fluid contains equal to or less than 10, 9, 8, 7, 6, 5, 4, 3, 2, 1, 0.1, 0.001, 0.0001, 0.0001 and equal to or greater than zero weight percent of other additional foaming stabilizing agents (e.g., in addition to the one or more antimony-containing compounds).

To increase the viscosity of an aqueous acid treatment fluid, a suitable gelling agent may be included in the acidizing fluid (often referred to as “gelling” the fluid). Gelling an aqueous acidic treatment fluid may be useful to prevent the acid from becoming prematurely spent and inactive. Additionally, without being limited by theory, gelling an aqueous acidic treatment fluid may enable the development of wider fractures so that live acid may be forced further into the formation from the wellbore. Gelling the acidic treatment fluid may delay the interaction of the acid with an acid soluble component in the wellbore or the formation. Moreover, gelling an aqueous acidic treatment fluid may permit better fluid loss control of the fluid. Acidic treatment fluids used in subterranean operations are typically water-based fluids that comprise gelling agents that may increase their viscosities, inter alia, to provide viscosity to control the rate of spending of the acid. These gelling agents are usually biopolymers or synthetic polymers that, when hydrated and at a sufficient concentration, are capable of forming a more viscous fluid. Common gelling agents include, without limitation, polysaccharides (such as xanthan), synthetic polymers (such as polyacrylamide), and surfactant gel systems (such as viscoelastic surfactants).

Accordingly, a gelling agent for providing viscosity to the acidizing fluid (e.g., the aqueous acid solution comprising the acid and the aqueous base fluid) can optionally be included in the acidizing fluid of this disclosure, for example, so that solids generated by the reaction of the acid with formation materials or HCl-acid insoluble solids freed by the reaction of the acid on the cementitious substrate, are suspended in the fluid and removed therewith. Gelling agents suitable for use in acidizing fluids of the present disclosure include, but are not limited to, biopolymers (e.g., xanthan, succinoglycan, and diutan), clarified biopolymers (e.g., clarified xanthan, clarified diutan, clarified scleroglucan), cellulose, cellulose derivatives (e.g., hydroxy ethyl cellulose, carboxyalkyl cellulose, carboxyalkyl hydroxyalkyl cellulose, hydroxypropyl cellulose), guar, and guar derivatives (e.g., hydroxypropyl guar, hydroxylalkyl guar, carboxyalkyl hydroxyalkyl guar, carboxymethyl guar). Suitable gelling agents also may include synthetic polymers (e.g., polyacrylamide, polyacrylate, polyacrylamide copolymers, and polyacrylate copolymers). Commercially available examples of suitable gelling agents include, but are not limited to, those that are available from Halliburton Energy Services, Inc., of Duncan, OK, under the trade name “WG-37” and “N-VIS®.”

Clarified biopolymers are described in U.S. Pat. No. 7,814,980, entitled, “Micro-Crosslinked Gels and Associated Methods”, the disclosure of which is hereby incorporated herein for purposes not contrary to this disclosure.

In embodiments, the gelling agent comprises scleroglucan and/or diutan. The gelling agent may be present in an acidic treatment fluid of the present disclosure in an amount of from about 1 lb/Mgal to about 250 lb/Mgal, from about 5 lb/Mgal to about 250 lb/Mgal, from about 10 lb/Mgal to about 200 lb/Mgal, or from about 15 lb/Mgal to about 190 lb/Mgal. Generally speaking, an acidic treatment fluid containing an organic acid may require less of a gelling agent than an acidic treatment fluid containing hydrochloric acid.

As noted in the text BIOPOLYMERs, VOLUME 6, POLYSACCHARIDES II: POLYSACCHARIDES FROM EUKARYOTES, by E. J. Vandamme (Editor), S. De Baets (Editor), Alexander Steinbuchel (Editor), ISBN: 3-527-30227-1; published by Wiley 2002, specifically Chapters 2 and 3, scleroglucan is a neutral fungal polysaccharide. Scleroglucan is a hydrophilic polymer, which is believed to have a tendency to thicken and stabilize water-based systems by conferring on them a relatively high viscosity, generally higher than that obtained in the case of xanthan, for example, at temperatures at or above about 200° F., for identical concentrations of active compounds. Scleroglucan also appears to be more resistant to pH and temperature changes than xanthan, and therefore, may impart more stable viscosity in such conditions. In certain aspects, the viscosity of a scleroglucan fluid may be virtually independent of pH between a pH of about 1 and about 12.5 up to a temperature limit of about 270° F. Generally, the main backbone polymer chain of scleroglucan comprises (1→3)β-D-glucopyranosyl units with a single P-D-glucopyranosyl group attached to every third unit on the backbone. Scleroglucan is thought to be resistant to degradation, even at high temperatures such as those at or above about 200° F., even after, e.g., 500 days in seawater. Viscosity data show that dilute solutions (e.g., about 0.5%) may be shear thinning and stable to at least 250° F. These viscosities illustrate, inter alia, the suitability of scleroglucan for viscosifying fluids. In embodiments wherein the gelling agent of the present disclosure comprises scleroglucan, one may include about 1 to about 200 lb/Mgal scleroglucan. In an acidic treatment fluid that comprises hydrochloric acid, a range may be from about 1 to about 120 lb/Mgal of scleroglucan.

As noted in the text BIOPOLYMERs, VOLUME 6, POLYSACCHARIDES II: POLYSACCHARIDES FROM EUKARYOTES, by E. J. Vandamme (Editor), S. De Baets (Editor), Alexander Steinbuchel (Editor), ISBN: 3-527-30227-1; published by Wiley 2002, specifically Chapters 2 and 3, and BIOPOLYMERs; (1999) vol 50; p. 496; Authors: B. H. Falch; A. Elgsaeter & B. T. Stokke, diutan gum is a polysaccharide designated as “S-657,” which is prepared by fermentation of a strain of sphingomonas. The diutan structure has been elucidated as a hexasaccharide having a tetrasaccharide repeat unit in the backbone that comprises glucose and rhamnose units and di-rhamnose side chain. It is believed to have thickening, suspending, and stabilizing properties in aqueous solutions. Diutan is composed principally of carbohydrates, about 12% protein, and about 7% (calculated as O-acetyl) acyl groups, the carbohydrate portion containing about 19% glucuronic acid, and the neutral sugars rhamnose and glucose in the approximate molar ratio of about 2:1. Details of the diutan gum structure may be found in an article by Diltz et al., “Location of O-acetyl Groups in 5-657 Using the Reductive-Cleavage Method,” CARBOHYDRATE RESEARCH, Vol. 331, p. 265-270 (2001), which is hereby incorporated by reference in its entirety. Details of preparing diutan gum may be found in U.S. Pat. No. 5,175,278, which is hereby incorporated by reference in its entirety. A suitable source of diutan is “GEOVIS XT,” which is commercially available from Kelco Oil Field Group, Houston, TX. In embodiments wherein the gelling agent of the present disclosure comprises diutan, one may include about 1 to about 200 lb/Mgal scleroglucan. In an acidic treatment fluid that comprises about 15% hydrochloric acid, a suitable range can be from about 1 to about 200 lb/Mgal of diutan.

One of skill in the art and with the help of this disclosure will be able to select a suitable gelling agent(s) for a specific operation. For example, acidic treatment fluids comprising xanthan generally have sufficient viscosity for lower temperature operations. At elevated temperatures (e.g., those above about 120° F. to about 150° F.) (e.g., from about 180 to 200° F.), however, the viscosity of such xanthan treatment fluids can be diminished. Consequently, xanthan may not be a suitable gelling agent for acidic treatment fluids when those fluids are used in wellbores that comprise elevated temperatures. Other gelling agents such as synthetic gelling agents (e.g., polyacrylamides) can be used, but may use considerable mixing or agitation to develop full viscosity. Conventional gelling agents, including guar and some synthetic polymers, may form acid insoluble residues or may be incompatible in an acidic fluid. Surfactant gel systems can be expensive, and can be sensitive to impurities, and work best in the presence of hydrocarbon breakers.

The gelling agents can be present in an acidic treatment fluid of this disclosure in an amount of from about 1 lb/Mgal to about 200 lb/Mgal, from about 10 lb/Mgal to about 200 lb/Mgal, or from about 10 lb/Mgal to about 150 lb/Mgal. In embodiments wherein multiple gelling agents are included, one may include about 1 lb/Mgal to about 200 lb/Mgal of each or the total of the gelling agents. In an acidic treatment fluid that comprises hydrochloric acid, one may include about 1 to about 200 lb/Mgal of the gelling agent(s). In an acidic treatment fluid that comprises about 15% hydrochloric acid, one may include about 1 to about 200 lb/Mgal of the gelling agent(s). A person of skill in the art with the benefit of this disclosure will recognize that any specific concentration or narrower range of concentrations of the gelling agents of this disclosure encompassed by the broader concentration ranges specifically articulated above may be used and/or may be particularly advantageous for a particular embodiment of this disclosure.

Another suitable gelling agent which can be utilized is comprised of a copolymer of about 0.01% to about 60% by weight acrylamide and the remainder selected from the group consisting of dialkylaminoethylmethacrylate, trialkylaminoethylmethacrylate quaternary salt and acrylamido alkane sulfonic acid. The trialkylaminoethylmethacrylate quaternary salt monomer has the structural formula:

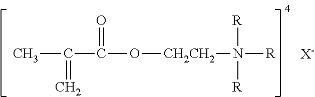

wherein R is methyl or ethyl and X⁻ is Cl, Br, I or CH₃OSO₃. The dialkylaminoethylmethacrylate monomer has the structural formula:

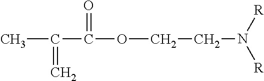

wherein R is methyl or ethyl. The acrylamido alkane sulfonic acid has the structural formula:

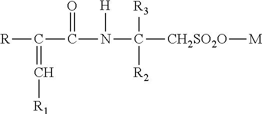

wherein R, R1, R2 and R3 are independently selected from hydrogen or alkyl having from 1 to 5 carbons and M is selected from hydrogen, sodium, potassium or ammonium.

Another suitable gelling agent which can be utilized is a copolymer of a quaternary ammonium salt and acrylamide, methylacrylamide or a monomer represented by the structural formula:

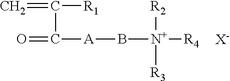

wherein R1 is hydrogen or methyl, R2 and R3 are each an alkyl group having 1 or 2 carbon atoms, R4 is hydrogen or an alkyl group having 1 or 2 carbon atoms, A is an oxygen atom or —NH, B is an alkyl group having 2 to 4 carbon atoms or a hydroxypropyl group and X is a counter anion. Such a gelling agent is more fully described in U.S. Pat. No. 5,332,507 issued on Jul. 26, 1994 to Braden et al. which is incorporated herein by reference thereto.

Yet another suitable gelling agent which can be utilized is comprised of a solution of a water soluble organic solvent having one or more ethoxylated fatty amines dissolved therein. Such a gelling agent is more fully described in U.S. Pat. No. 4,324,669 issued on Apr. 13, 1982 to Norman et al. which is incorporated herein by reference thereto.

The gelling agent utilized can generally be included in an acidizing fluid of this disclosure in an amount in the range of from about 0.4% to about 5% by weight of the aqueous acid solution therein. The gelling agent can be an acidizing or a non-acidizing gelling agent.

In embodiments, the acidic treatment fluids of the present disclosure may be foamed. In such embodiments, the acidic treatment fluids also comprise a physical foaming agent (e.g., a gas) and/or a chemical foaming agent (e.g., a surfactant).

In embodiments, the acidic treatment fluid is foamed with and comprises a gas. While various gases can be utilized for foaming the acidic treatment fluids of this disclosure, nitrogen, carbon dioxide, air, hydrocarbons (e.g., methane, ethane, propane, and butane) and mixtures thereof are provided as suitable examples. In embodiments, the gas utilized for forming the foamed acidizing fluids of this disclosure can comprise air or nitrogen or a combination thereof. In embodiments, the gas may be present in the acidic treatment fluid of this disclosure in an amount in the range of from about 5% to about 95% by volume of the treatment fluid, from about 5% to about 90% by volume of the treatment fluid, or in the range of from about 20% to about 80%, from about 10% to about 90% by volume of the treatment fluid, or from about 15% to about 85% by volume of the treatment fluid. The amount of gas to incorporate into the fluid may be affected by factors including the viscosity of the fluid and wellhead pressures involved in a particular application. In embodiments, the gas can be present in an amount sufficient to foam the gelled aqueous acid solution (e.g., solution comprising the gelling agent, acid, and aqueous base fluid), generally in an amount in the range of from about 20% to about 80% by volume of the aqueous acid solution. In embodiments, the acidic treatment fluid comprises a gas in the amount of from about 5% to about 95%, about 10% to about 90%, or about 15% to about 85% by volume.

Suitable chemical foaming agents that can be utilized to foam and stabilize the acidic treatment fluids of this disclosure can include, but are not limited to, alkylamidobetaines such as cocoamidopropyl betaine, alpha-olefin sulfonate, trimethyltallowammonium chloride, C8 to C22 alkylethoxylate sulfate and trimethylcocoammonium chloride. In embodiments, cocoamidopropyl betaine is utilized. Other suitable surfactants available from Halliburton Energy Services include: 19N, G-Sperse Dispersant, Morflo III® surfactant, Hyflo (R) IV M surfactant, Pen-88M™ surfactant, HC-2 Agent, Pen-88 30 HT™ surfactant, SEM-7™ emulsifier, Howco-Suds™ foaming agent, Howco Sticks™ surfactant, A-Sperse™ Dispersing aid for acid additives, SSO-21E surfactant, and SSO-21MW™ surfactant. In embodiments, the acidic treatment fluid comprises at least one of the following: an alkylamidobetaine; cocoamidopropyl betaine; alpha-olefin sulfonate; trimethyltallowammonium chloride; a C8 to C22 alkylethoxylate sulfate; or trimethylcocoammonium chloride. Other suitable foaming agents and foam stabilizing agents may be included as well, which will be known to those skilled in the art with the benefit of this disclosure. The foaming agent can generally be present in an acidic treatment fluid of the present disclosure in an amount in the range of from about 0.1% to about 5.0%, 0.1% to about 4.0% by weight, or in the amount of from about 0.2% to about 1.0%, or about 0.6%. by weight.

The foaming agent can include a surfactant. In embodiments, the acidic treatment fluids of the present disclosure may include surfactants, e.g., to improve the compatibility of the acidic treatment fluids with other fluids (like any formation fluids) that may be present in the subterranean formation and/or wellbore. A person of ordinary skill, with the benefit of this disclosure, will be able to identify the type of surfactant as well as the appropriate concentration of surfactant to be used. Examples of surfactants that may be suitable include, but are not limited to, ethoxylated nonyl phenol phosphate esters, nonionic surfactants, cationic surfactants, anionic surfactants, amphoteric/zwitterionic surfactants, alkyl phosphonate surfactants, linear alcohols, nonylphenol compounds, alkyoxylated fatty acids, alkylphenol alkoxylates, ethoxylated amides, ethoxylated alkyl amines, amphoteric surfactants (such as betaines), methyl ester sulfonates (e.g., as described in U.S. Patent Application Nos. 2006/0180310, 2006/0180309, 2006/65 0183646 and U.S. Pat. No. 7,159,659, the relevant disclosures of which are incorporated herein by reference), hydrolyzed keratin (e.g., as described in U.S. Pat. No. 6,547,871, the relevant disclosure of which is incorporated herein by reference), sulfosuccinates, taurates, amine oxides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives thereof, and mixtures thereof. Suitable surfactants may be used in a liquid or powder form. Where used, the surfactants can be present in the acidic treatment fluid of this disclosure in an amount sufficient to prevent incompatibility with formation fluids or wellbore fluids. In an embodiment where liquid surfactants are used, the surfactants can be present in an amount in the range of from about 0.01% to about 5.0% by volume of the acidic treatment fluid. In embodiments, the liquid surfactants can be present in an amount in the range of from about 0.01% to about 2.0% by volume of the acidic treatment fluid. In embodiments where powdered surfactants are used, the surfactants can be present in an amount in the range of from about 0.001% to about 0.5% by weight of the acidic treatment fluid. Examples of surfactants that may be suitable include non-emulsifiers commercially available from Halliburton Energy Services, Inc., of Duncan, OK, under the tradenames LOSURF-300M™ nonionic surfactant, LOSURF-357™ nonionic surfactant, LOSURF-400™ surfactant, LOSURF-2000S™ solid surfactant, LOSURF-2000M™ solid surfactant, and LOSURF-259™ nonionic non-emulsifier. Another example of a surfactant that may be suitable is a non-emulsifier commercially 30 available from Halliburton Energy Services, Inc., of Duncan, OK, under the tradename NEA-96MTM Surfactant. Other examples of surfactants that may be suitable that are commercially available from Halliburton Energy Services in Duncan, OK. are products SGA-1, EFS-1, EFS-2, EFS-3, and EFS-4. Other surfactants that may be suitable may include betaines and quaternary ammonium compounds. Examples of betaines that are commercially available include MIRATAINE® and MIRATAINE® BET 0-30 both available for Rhodia and REWOTERIC® AM TEG available for Degussa. Examples of commercially available quaternary ammonium compounds include ARQUAD® 22-80 and ETHOQUAD® 0/12 PG both available from Akzo Nobel and GENAMIN KDMP available from Clariant. It may be beneficial to add a surfactant to an acidic treatment fluid of the present disclosure as that fluid is being pumped downhole, among other things, to help reduce the possibility of forming emulsions with the formation crude oil. Furthermore, in embodiments, microemulsion additives optionally may be included in the treatment fluids of the present disclosure. Examples of microemulsion additives that may be suitable include, but are not limited to, PEN-88MTM surfactant, PEN-88HT™ surfactant, SSO-21E surfactant, SSO-21MwrM surfactant, GASPERM 1000™ Microemulsion Surfactant/Solvent Additive, Transcend 425, and Transcend 725, which are all commercially available from Halliburton Energy Services, Inc., of Duncan, OK. Other microemulsion additives that may be suitable are MA-845 additive and MA-844 additive, commercially available from CESI Chemical of Duncan, OK; SHALESURF 1000 additive, commercially available from Frac Tech Services of Aledo, TX; and those disclosed in U.S. Patent App. No. 2003/0166472, the relevant disclosure of which is incorporated by reference. It is noted that, in embodiments, it may be beneficial to add a surfactant to a treatment fluid of the present disclosure as that fluid is being pumped downhole to help eliminate the possibility of foaming. However, in those embodiments where it is desirable to foam the treatment fluids of the present disclosure, surfactants such as those comprising inner salt of alkyl amines, such as HY-CLEAN(HC-2)™ surface-active suspending agent (e.g., comprising alkyl amines and sodium chloride) or AQF-2™ additive, both commercially available from Halliburton Energy Services, Inc., of Duncan, OK, may be used. Additional examples of foaming agents that may be utilized to foam and stabilize the treatment fluids of this disclosure include, but are not limited to, betaines, amine oxides, methyl ester sulfonates, alkylamidobetaines such as cocoamidopropyl betaine, alpha-olefin sulfonate, trimethyltallowammonium chloride, C8 to C22 alkylethoxylate sulfate and trimethylcocoammonium chloride. Other suitable surfactants that may or may not be foamers in a particular application that are available from Halliburton Energy Services include: 19N, G-SPERSE dispersant, HOWCO-SUDS™ foaming agent, and A-SPERSE™ dispersing aid for acid additives. Other suitable foaming agents and foam stabilizing agents may be included as well, which will be known to those skilled in the art with the benefit of this disclosure.

In embodiments, the treatment fluids described herein can comprise an aqueous carrier fluid as their continuous phase. Suitable aqueous carrier fluids may include, for example, fresh water, acidified water, salt water, seawater, brine (e.g., a saturated salt solution), or an aqueous salt solution (e.g., a non-saturated salt solution). Aqueous carrier fluids may be obtained from any suitable source. Given the benefit of the present disclosure, one of ordinary skill in the art will be able to determine a suitable aqueous carrier fluid for utilization in the embodiments described herein.

The aqueous base fluids of the treatment fluids of the present disclosure generally comprise fresh water, salt water, or a brine (e.g., a saturated salt water). Other water sources may be used, including those comprising divalent or trivalent cations, e.g., magnesium, calcium, zinc, or iron. Monovalent brines can be utilized, and, where used, may be of any suitable weight. One skilled in the art will readily recognize that an aqueous base fluid containing a high level of multi-valent ions can be tested for compatibility prior to use. Salts optionally may be added to the water source, inter alia, to produce a treatment fluid having a desired density or other characteristics. One of ordinary skill in the art with the benefit of this disclosure will recognize the particular type of salt appropriate for particular application, given considerations such as protection of the formation, the presence or absence of reactive clays in the formation adjacent to the wellbore, compatibility with the other acidic treatment fluid additives, and the factors affecting wellhead control. A wide variety of salts may be suitable. Examples of suitable salts include, inter alia, potassium chloride, sodium bromide, ammonium chloride, cesium formate, potassium formate, sodium formate, sodium nitrate, calcium bromide, zinc bromide, and sodium chloride. In embodiments, the aqueous base fluid comprises a 5% ammonium chloride brine with hydrofluoric acid or an organic acid. An artisan of ordinary skill with the benefit of this disclosure will recognize the appropriate concentration of a particular salt to achieve a desired density given factors such as the environmental regulations that may pertain. Also, the composition of the water used also will dictate whether and what type of salt is appropriate. The amount of the base fluid in an acidic treatment fluid of the present disclosure will vary depending on the purpose of the fluid, the formation characteristics, and whether the fluid will be foamed.

As noted above, the water utilized to form the aqueous acid solution can be any aqueous fluid which does not adversely react with the acid, or other components in the acidizing fluid. For example, the water can be fresh water, brine, salt containing water solutions such as sodium chloride solutions, potassium chloride solutions, ammonium chloride solutions, seawater, brackish water or the like. As described further hereinbelow, the aqueous acid solution can also include one or more corrosion inhibitors and corrosion inhibitor intensifiers to prevent the aqueous acid solution from corroding metal pumps, tubular goods and the like. Some such corrosion inhibitors, corrosion inhibitor intensifiers and other additives are described hereinbelow.

As noted above, water sources including those comprising monovalent, divalent, or trivalent cations (e.g., magnesium, calcium, zinc, or iron) can be used, and, where used, may be of any weight. If a water source is used that contains such divalent or trivalent cations in concentrations sufficiently high to be problematic, then such divalent or trivalent salts may be removed, either by a process such as reverse osmosis, or by raising the pH of the water in order to precipitate out such divalent salts to lower the concentration of such salts in the water before the water is used. Another method would be to include a complexing agent or chelating agent to chemically bind the problematic ions to prevent their undesirable interactions with the clarified xanthan. Suitable complexing agents include, but are not limited to, citric acid or sodium citrate, ethylene diamine tetra acetic acid (“EDTA”), hydroxyethyl ethylenediamine triacetic acid (“HEDTA”), dicarboxymethyl glutamic acid tetrasodium salt (“GLDA”), methyl glycine diaceticacid (“MGDA”) diethylenetriaminepentaacetic acid (“DTPA”), propylenediaminetetraacetic acid (“PDTA”), N-phosphonoalkyl diacetic acids (including but not limited to N-phosphonomethyl iminodiacetic acid (“PMIDA”), ethylenediaminedi(o-hydroxyphenylacetic) acid (“EDDHA”), glucoheptonic acid, gluconic acid, and the like, and nitrilotriacetic acid (“NTA”). Other chelating agents also may be suitable. One skilled in the art will readily recognize that an aqueous base fluid containing a high level of multi-valent ions can be tested for compatibility prior to use.

In embodiments, the base fluids suitable for use in the acidic treatment fluids of this disclosure may be a foamed fluid (e.g., a liquid that comprises a gas such as nitrogen, carbon dioxide, air or methane). As used herein, the term “foamed” also refers to fluids such as co-mingled fluids. In embodiments, it may desirable that the base fluid is foamed to, inter alia, reduce the amount of base fluid that is required, e.g. in water sensitive subterranean formations, to reduce fluid loss to the subterranean formation, and/or to provide enhanced proppant suspension. In addition, in embodiments where the acidic treatment fluids of this disclosure are used for fluid diversion, it may be desirable that the acidic treatment fluid be foamed. While various gases can be utilized for foaming the acidic treatment fluids of this invention, nitrogen, carbon dioxide, air, and mixtures thereof can be particularly suitable. In examples of such embodiments, the gas may be present in an acidic treatment fluid of this disclosure in an amount in the range of from about 5% to about 98% by volume of the treatment fluid, or in the range of from about 20% to about 80%. The amount of gas to incorporate into the fluid may be affected by factors including the viscosity of the fluid and wellhead pressures involved in a particular application.

If desired, the acidic treatment fluids of this disclosure may also be used in the form of an emulsion. An example of a suitable emulsion may comprise an aqueous base fluid comprising a clarified xanthan gelling agent and a suitable hydrocarbon. In embodiments, the emulsion may comprise approximately 30% of an aqueous base fluid and 70% of a suitable hydrocarbon. In embodiments, the external phase of the emulsion may be aqueous. In embodiments, it may be desirable to use an emulsion to, inter alia, reduce fluid loss to the subterranean formation, and/or to provide enhanced proppant suspension. Other benefits and advantages to using emulsions in the methods of this disclosure will be evident to one of ordinary skill in the art. For example, CEA is 30-40% hydrocarbon and 60-70% aqueous (acid) and uses AF-70 (emulsifying surfactant) containing fatty acid amine, ethylene glycol, heavy aromatic petroleum naphtha, acetic acid, naphthalene.

The acidic treatment fluids of this disclosure may vary widely in density. One of ordinary skill in the art with the benefit of this disclosure will recognize the particular density that is most appropriate for a particular application. In embodiments, the density of the non-foamed acidic treatment fluids of this disclosure generally may approximate the density of water. In embodiments, the density of the non-foamed acidic treatment fluids of this disclosure generally may range from about 8.3 pounds per gallon (“ppg”) to about 30 ppg, from about 8.3 pounds per gallon (“ppg”) to about 19.2 ppg, or from about 15 pounds per gallon (“ppg”) to about 30 ppg. One of ordinary skill in the art with the benefit of this disclosure will recognize that the density of any particular acidic treatment fluid of this disclosure may also vary depending on the addition of certain additives, including, but not limited to, inorganic salts, proppant, gas, fluid loss control additives, alcohols, glycols, and/or hydrocarbons. Furthermore, the desired density for a particular acidic treatment fluid may depend on fluids in the wellbore and/or characteristics of the subterranean formation, including, inter alia, the hydrostatic pressure required to control the fluids of the subterranean formation during placement of the acidic treatment fluids, and the hydrostatic pressure which may damage the subterranean formation. For example, if the acidic treatment fluid remains in the wellbore, the density of the acidic treatment fluid may be adjusted to, inter alia, prevent the changing of position of a fluid relative to another fluid with a different density, thereby leaving the acidic treatment fluid at the correct placement within the wellbore. The density of a treatment fluid of this disclosure may be adjusted, among other ways, by adding salts and/or brines. The types of salts or brines used to achieve the desired density of the acidic treatment fluid can be chosen based on factors such as compatibility with the formation, crystallization temperature, and compatibility with other treatment and/or formation fluids. Availability and environmental impact also may affect this choice.

In embodiments, the acidic treatment fluid may comprise a brine. Brines suitable for use in embodiments of this disclosure may include those that comprise monovalent, divalent, or trivalent cations. Some divalent or trivalent cations, such as magnesium, calcium, iron, and zinc, may, in some concentrations and at some pH levels, cause undesirable crosslinking of a gelling agent. As noted above, if a water source is used which contains such divalent or trivalent cations in concentrations sufficiently high to be problematic, then such divalent or trivalent salts may be removed, either by a process such as reverse osmosis, or by raising the pH of the water in order to precipitate out such salts to lower the concentration of such salts in the water before the water is used. Another method would be to include a chelating agent to chemically bind the problematic ions to prevent their undesirable interactions with the xanthan. As used herein, the term “chelating agent” or “chelant” also refers to sequestering or complexing agents and the like. As noted above, suitable chelants include, but are not limited to, citric acid or sodium citrate. Other chelating agents also are suitable. Brines, where used, may be of any weight. Examples of suitable brines include calcium bromide brines, zinc bromide brines, calcium chloride brines, sodium chloride brines, sodium bromide brines, potassium bromide brines, potassium chloride brines, sodium nitrate brines, sodium formate brines, potassium formate brines, cesium formate brines, magnesium chloride brines, sodium sulfate, potassium nitrate, mixtures thereof, and the like. The brine chosen can be compatible with the formation and can have a sufficient density to provide the appropriate degree of well control. Additional salts may be added to a water source, e.g., to provide a brine, and a resulting acidic treatment fluid, having a desired density. The amount of salt that is added can be the amount necessary for formation compatibility, such as the amount necessary for the stability of clay minerals, taking into consideration the crystallization temperature of the brine, e.g., the temperature at which the salt precipitates from the brine as the temperature drops. Suitable brines may include seawater and/or formation brines.

Suitable acids for inclusion in the treatment fluids of the present disclosure include any acid suitable for use in a subterranean application. Examples include hydrochloric acid, hydrofluoric acid, acetic acid, formic acid, citric acid, ethylene diamine tetra acetic acid (“EDTA”), glycolic acid, sulfamic acid, N-phosphonomethyl iminodiacetic acid (“PMIDA”), and derivatives or a combination thereof. Hydrochloric acid, acetic acid, or formic acid can be utilized in certain applications. The term “derivative” is defined herein to include any compound that is made from one of the listed compounds, for example, by replacing one atom in the listed compound with another atom or group of atoms, rearranging two or more atoms in the listed compound, ionizing one of the listed compounds, or creating a salt of one of the listed compounds. The choice of aqueous base fluid and acid may be chosen vis-a-vis the other, among other reasons, so that the proper synergistic effect is achieved. The concentration and type of acid selected may be based upon the function of the acid (e.g., scale removal, fracture acidizing, matrix acidizing, removal of fluid loss filter cakes and pills, perforation clean-out (reduced formation breakdown pressure), and the like), compatibility with crude oil, and the mineralogy and temperature of the formation. One should be mindful that certain concentrations of acids, such as formic acid, may have a tendency to form precipitates upon spending. A precipitation control additive (e.g., aluminum chloride) may be desirable to include as well depending on the acid and the formation.

With hydrochloric acid, an aqueous hydrochloric acid solution having a hydrochloric acid concentration in the range of from about 2.5% to about 37%, from about 5% to about 35%, from about 5% to about 30%, or from about 10% to about 35% by weight of the solution can be employed, in embodiments. In embodiments, an aqueous acid solution for use in accordance with the present disclosure comprises an acid solution having an acid concentration in the range of from about 15% to about 35%, from about 5% to about 35%, from about 5% to about 30%, or from about 10% to about 35% by weight of the solution.

Further factors that may be taken into account in determining a suitable pH for a treatment fluid include, for example, the composition of the subterranean formation and the desired acidizing rate. In embodiments, the treatment fluids described herein can have a pH value of about 5.5 or lower, about 3 or lower, or about 2.5 or lower, or about 2 or lower, or about 1.5 or lower, or about 1 or lower. In embodiments, the pH of the treatment fluids may range between about 5.5 and about 0, about 3 and about 0, or between about 2.5 and about 0, or between about 2 and about 0, or between about 1.5 and about 0, or between about 1 and about 0.

Although described as the treatment fluids of this disclosure including an acid, acid-generating compounds can also be used in the treatment fluids in a substantially equivalent manner. The acid or acid-generating compound may be a mineral acid, an organic acid or any combination thereof. In embodiments, a suitable acid can be hydrochloric acid, or hydrochloric acid in combination with an organic acid. Hydrobromic acid alone or in combination with an organic acid may also be used. Organic acids may also be used in place of a mineral acid. Suitable organic acids may include, for example, formic acid, acetic acid, chloroacetic acid, dichloroacetic acid, trichloroacetic acid, methanesulfonic acid and the like. Examples of suitable acid generating compounds that may be used in embodiments described herein include, for example, esters, aliphatic polyesters, orthoesters, poly(orthoesters), poly(lactides), poly(glycolides), poly(e-caprolactones), poly(hydroxybutyrates), poly(anhydrides), ethylene glycol monoformate, ethylene glycol diformate, diethylene glycol diformate, glyceryl monoformate, glyceryl diformate, glyceryl triformate, triethylene glycol diformate, and formate esters of pentaerythritol.

In embodiments, an amount of the acid or acid-generating compound present in the treatment fluid can be sufficient to produce a desired pH value. When the acid comprises a mineral acid such as hydrochloric acid, for example, the acid may be initially present in the treatment fluid in an amount ranging between about 1% to about 10% of the treatment fluid by weight, in an amount ranging between about 1% to about 5% of the treatment fluid by weight, or in an amount ranging between about 5% to about 10% of the treatment fluid by weight. In embodiments, the treatment fluid may initially contain greater than about 1% hydrochloric acid by weight, or greater than about 5% hydrochloric acid by weight. Since organic acids are generally less acidic than are mineral acids, when the treatment fluid comprises an organic acid, the organic acid may comprise up to about 20% of the treatment fluid by weight, particularly between about 1% to about 20% of the treatment fluid by weight, or between about 10% to about 20% of the treatment fluid by weight.

With some methods and compositions, the concentration of various components of the acidizing fluid, such as the amount of acid content, can be difficult to adjust while performing the acidization. However, in various embodiments, the composition can be mixed on the fly, providing facile adjustment of the concentration of various components used for acidization. In various embodiments, by mixing the composition on the fly, the strength of the acid can be quickly and easily controlled, allowing for more precise control over the rate and amount of acidization occurring in various locations downhole at various times during the treatment.

In embodiments, the acidizing fluid comprises gelling agents selected from saccharides and acrylamide based polymers, without a suspension aid.

In additional embodiments, the treatment fluids described herein may further comprise any number of additives that are commonly used in downhole operations. In embodiments, the acidizing treatment fluids of this disclosure may comprise any additional additive that may be suitable in a particular application of this disclosure, including, but not limited to, any of the following: hydrate inhibitors, clay stabilizers, catalysts, bactericides, salt substitutes (such as tetramethyl ammonium chloride), scale inhibitors (e.g., silica scale control additives), relative permeability modifiers (such as HPT-1™ chemical additive available from Halliburton Energy Services, Duncan, OK), scavengers (e.g., H₂S scavengers, CO₂ scavengers, O₂ scavengers, sulfide scavengers), fibers, nanoparticles, consolidating agents (such as resins and/or tackifiers), corrosion inhibitors, corrosion inhibitor intensifiers, pH control additives (e.g., buffers), surfactants, breakers, delayed release breakers, fluid loss control additives, scale inhibitors, asphaltene inhibitors, paraffin inhibitors, salts, bactericides, crosslinkers, stabilizers, chelants, foamers, defoamers, emulsifiers, demulsifiers, iron control agents, solvents, mutual solvents, particulate diverters, gas phase, gas, carbon dioxide, nitrogen, biopolymers, synthetic polymers, friction reducers, foaming agents, defoaming agents, antifoaming agents, proppants or other particulates, particulate diverters, salts, acids, fluid loss control additives, clay control agents, dispersants, flocculants, lubricants, breakers, friction reducers, bridging agents, viscosifiers, weighting agents, solubilizers, surfactants, gel stabilizers, anti-oxidants, polymer degradation prevention additives, combinations thereof, or the like. The acidic treatment fluids of this disclosure also may include other additives that may be suitable for a given application, as will be recognized by a person of ordinary skill in the art, with the benefit of this disclosure. Combinations of these additives can be used as well. Given the benefit of the present disclosure, one of ordinary skill in the art will be able to formulate a treatment fluid having properties suitable for a given application.

Examples of hydrate inhibitors that may be suitable for use include thermodynamic inhibitors, methanol, mutual solvents, monoethylene glycol (MEG), di-ethylene glycol (DEG), glycols, kinetic inhibitors, and anti-agglomerants. Others known in the art may be suitable as well.

In embodiments, the acidic treatment fluids of this disclosure may contain bactericides, inter alia, to protect both the subterranean formation as well as the viscosified treatment fluid from attack by bacteria. Such attacks may be problematic because they may lower the viscosity of the acidic treatment fluid, resulting in poorer performance, such as poorer sand suspension properties, for example. Any bactericides known in the art are suitable. An artisan of ordinary skill with the benefit of this disclosure will be able to identify a suitable bactericide and the proper concentration of such bactericide for a given application. Examples of suitable bactericides include, but are not limited to, a 2,2-dibromo-3-nitrilopropionamide, commercially available under the tradename BE-3S™ biocide from Halliburton Energy Services, Inc., of Duncan, OK, and a 2-bromo-2-nitro-1,3-propanediol commercially available under the tradename BE-6™ biocide from Halliburton Energy Services, Inc., of Duncan, OK. In embodiments, the bactericides are present in the acidic treatment fluid in an amount in the range of from about 0.001% to about 1.0% by weight of the acidic treatment fluid. In embodiments, when bactericides are used in the viscosified acidic fluids of this disclosure, they may be added to the acidic treatment fluid before the gelling agent is added.

Examples of corrosion inhibitors that may be suitable for use include acetylenic alcohols, Mannich condensation products (such as those formed by reacting an aldehyde, a carbonyl containing compound and a nitrogen containing compound), unsaturated carbonyl compounds, unsaturated ether compounds, formamide, formic acid, formates, other sources of carbonyl, iodides, terpenes, and aromatic hydrocarbons, coffee, tobacco, gelatin, thio-compounds, cinnamaldehyde, cinnamaldehyde derivatives, fluorinated surfactants, quaternary derivatives of heterocyclic nitrogen bases, quaternary derivatives of halomethylated aromatic compounds, formamides, combinations of such compounds used in conjunction with iodine, quaternary ammonium compounds, cuprous iodide; cuprous chloride; an antimony compound; an antimony oxide; an antimony halide; antimony tartrate; antimony citrate; an alkali metal salt of an antimony tartrate and antimony citrate; an alkali metal salt of pyroantimonate and an antimony adduct of ethylene glycol; a bismuth compound; a bismuth oxide; a bismuth halide; a bismuth tartrate; a bismuth citrate; an alkali metal salts of bismuth tartrate and bismuth citrate; iodine and combinations thereof. Corrosion inhibitors that may be suitable are available from Halliburton Energy Services and include: “MSA-II™” corrosion inhibitor, “MSA-III” corrosion inhibitor, “HAI-25 E+” environmentally friendly low temp corrosion inhibitor, “HAI-404™” acid corrosion inhibitor, “HAI-50™” Inhibitor, “HAI-60™” Corrosion inhibitor, “HAI-62™” acid corrosion inhibitor, “HAI-65™” Corrosion inhibitor, “HAI-72E+™” Corrosion inhibitor, “HAI-75™” High temperature acid inhibitor, “HAI-8IM™” Acid corrosion inhibitor, “HAI-85™” Acid corrosion inhibitor, “HAI-85MTM” Acid corrosion inhibitor, “HAI-202 Environmental Corrosion Inhibitor,” “HAI-OS” Corrosion Inhibitor, “HAI-GE” Corrosion Inhibitor, “FDP-S692-03” Corrosion inhibitor for organic acids, “FDP-S656AM-02” and “FDPS656BW-02” Environmental Corrosion Inhibitor System, “HII-500” Corrosion inhibitor intensifier, “HII-500M” Corrosion inhibitor intensifier, “HII-124” Acid inhibitor intensifier, “HII-124B” Acid inhibitor intensifier, “HII-124C™” Inhibitor intensifier, and “HII-124F™” corrosion inhibitor intensifier.

In embodiments, a corrosion inhibitor activator may be included. Examples of corrosion inhibitor activators that may be used include, but are not limited to, cuprous iodide; cuprous chloride; antimony compounds such as antimony oxides, antimony halides, antimony tartrate, antimony citrate, alkali metal salts of antimony tartrate and antimony citrate, alkali metal salts of pyroantimonate and antimony adducts of ethylene glycol; bismuth compounds such as bismuth oxides, bismuth halides, bismuth tartrate, bismuth citrate, alkali metal salts of bismuth tartrate and bismuth citrate; iodine; iodide compounds; formic acid; and mixtures of the foregoing activators such as a mixture of formic acid and potassium iodide. Corrosion inhibitors intensifiers that may be suitable are available from Halliburton Energy Services and include: “HII-500™” Corrosion inhibitor intensifier, “HII-500M™” Corrosion inhibitor intensifier, “HII-124B” Acid inhibitor intensifier, “HII-124C™” Inhibitor intensifier, and “HII-124F™” corrosion inhibitor intensifier.

The amount of a corrosion inhibitor to include in an acidic treatment fluid of this disclosure will depend on many factors, including but not limited to, the metallurgy the acid will contact, contact time, temperature, other acid blend additives, etc. Where included, the amount of a corrosion inhibitor to include may range from about 0.01% to about 6% or from about 0.01% to about 6% by volume where liquid products are used and from about 0.5% to about 200% by weight where solid products are used.

Suitable iron control agents are available from Halliburton Energy Services and include: FE-2™ Iron sequestering agent, FE-2A™ Buffering agent, FE-3™ Iron control agent, FE-3A™ Iron control agent, FE-4™ Iron control agent, FE-5A™ Iron control agent, FERCHEK® Ferric iron inhibitor, FERCHEK® A Reducing agent, and FERCHEK® SC Iron control system. Other suitable iron control agents include those described in U.S. Pat. Nos. 6,315,045, 6,525,011, 6,534,448, and 6,706,668, the relevant disclosures of which are hereby incorporated by reference.

In embodiments, a pH control additive may be included, which may comprise a chelating agent. When added to the treatment fluids of this disclosure, such a chelating agent, among other functions, may chelate any dissolved iron (or other divalent or trivalent cation) that may be present in the water. Such chelation may prevent such ions from crosslinking the gelling agent molecules. Such crosslinking may be problematic, inter alia, because it may cause severe filtration problems, prevent injection in to the formation to optimize iron control, and/or cause polymer break or the formation of residue in the formation. Any suitable chelating agent may be used with this disclosure. Examples of chelating agents that may be suitable include, but are not limited to, an anhydrous form of citric acid, a solution of citric acid dissolved in water, and sodium citrate. Other chelating agents that may be suitable for use with this disclosure include, inter alia, nitrilotriacetic acid and any form of ethylene diamine tetracetic acid (“EDTA”) or its salts, hydroxyethylethylenediaminetriacetic acid (“HEDTA”), dicarboxymethyl glutamic acid tetrasodium salt (“GLDA”), diethylenetriaminepentaacetic acid (“DTPA”), propylenediaminetetraacetic acid (“PDTA”), N-phosphonomethyliminodiacetic acid (“PMIDA”) ethylenediaminedi(o-hydroxyphenylacetic) acid (“EDDHA”), glucoheptonic acid, gluconic acid, sodium citrate, phosphonic acid, salts thereof, and the like. In embodiments, the chelating agent may be a sodium or potassium salt form of the chelating agent. Generally, the chelating agent may be present in an amount sufficient to prevent crosslinking of the gelling agent molecules by any free iron (or any other divalent or trivalent cation) that may be present. In one embodiment, the chelating agent may be present in an amount of from about 0.02% to about 2.0% by weight of the treatment fluid. One of ordinary skill in the art with the benefit of this disclosure will recognize the suitable bases that may be used to achieve a desired pH an amount in the range of from about 0.02% to about 0.5% by weight of the treatment fluid. One of ordinary skill in the art with the benefit of this disclosure will be able to determine the proper concentration of optional chelating agents for a particular application.

In embodiments, the optional pH control additive may be an acid, which may comprise any known acid, including but not limited to the acid already included in the acidic treatment fluids of this disclosure. Examples of acids that may be suitable include, inter alia, hydrochloric acid, hydrofluoric acid, phosphonic acid, p-toluenesulfonic acid, acetic acid, formic acid, citric acid, derivatives thereof, and combinations thereof.

In embodiments, the pH control additive may be an acid composition. Examples of suitable acid compositions may comprise an acid, an acid generating compound, and combinations thereof. Any known acid may be suitable for use with the treatment fluids of this disclosure. Examples of acids that may be suitable for use in this disclosure include, but are not limited to organic acids (e.g., formic acids, acetic acids, carbonic acids, citric acids, glycolic acids, lactic acids, ethylenediaminetetraacetic acid (“EDTA”), hydroxyethyl ethylenediamine triacetic acid (“HEDTA”), p-toluenesulfonic acid, methane sulfonic acid and the like), inorganic acids (e.g., hydrochloric acid, hydrofluoric acid, phosphonic acid, p-toluenesulfonic acid, and the like), and combinations thereof. Examples of acid generating compounds that may be suitable for use in this disclosure include, but are not limited to, esters, aliphatic polyesters, ortho esters, which may also be known as ortho ethers, poly (ortho esters), which may also be known as poly(ortho ethers), poly(lactides), poly (glycolides), poly(E-caprolactones), poly(hydroxybutyrates), poly(anhydrides), or copolymers thereof. Derivatives and combinations also may be suitable. The term “copolymer” as used herein is not limited to the combination of two polymers, but includes any combination of polymers, e.g., terpolymers and the like. Other suitable acid-generating compounds include: esters including, but not limited to, ethylene glycol monoformate, ethylene glycol diformate, diethylene glycol diformate, glyceryl monoformate, glyceryl diformate, glyceryl triformate, triethylene glycol diformate and formate esters of pentaerythritol. An example of a suitable acid generating compound is a citrate ester commercially available from Halliburton Energy Services, Inc., of Duncan, OK, under the tradename MATRIXFLO™ II Breaker. Other suitable materials may be disclosed in U.S. Pat. Nos. 6,877,563 and 7,021,383, the disclosures of which are incorporated by reference.

The optional pH control additive also may comprise a base to elevate the pH of the treatment fluid, for example, when this fluid is used as a diverting fluid. Any known base that is compatible with the gelling agents comprising clarified xanthan can be used in the viscosified treatment fluids of this disclosure. Examples of bases that may be suitable include, but are not limited to, sodium hydroxide, potassium carbonate, potassium hydroxide, sodium bicarbonate, sodium carbonate, derivatives thereof, and combinations thereof. An example of a base that may be suitable is a solution of 25% sodium hydroxide commercially available from Halliburton Energy Services, Inc., of Duncan, OK, under the tradename “MO-67™” pH control agent. An example of a base solution that may be suitable is a solution of potassium carbonate commercially available from Halliburton Energy Services, Inc., of Duncan, OK, under the tradename “BA-40L™” buffering agent. One of ordinary skill in the art with the benefit of this disclosure will recognize the suitable bases that may be used to achieve a desired pH elevation in a particular application of this disclosure.

In embodiments, the optional pH control additive may comprise a combination of an acid and a chelating agent or a base and a chelating agent. Such combinations may be suitable, inter alia, when the addition of a chelating agent (e.g., in an amount sufficient to chelate the iron present) is insufficient by itself to achieve the desired pH level.

Suitable pH control additives, in embodiments, may comprise bases, chelating agents, acids, or combinations of chelating agents and acids or bases. A pH control additive may be utilized to maintain the pH of the treatment fluid at a desired level, e.g., to improve the dispersion of the gelling agent in the aqueous base fluid. In some instances, it may be beneficial to maintain the below 3. Suitable pH control additives are those additives that assist in maintaining the pH of an acidic treatment fluid very low, and may include glycolic acids, acetic acids, lactone derivatives, formic acid, carbonic acid, sulfamic acid, and the like.

While typically not required, the acidic treatment fluids of this disclosure can also comprise breakers capable of reducing the viscosity of the acidic treatment fluid at a desired time. Examples of such breakers that may be suitable for the acidic treatment fluids of this disclosure include, but are not limited to, sodium chlorite, hypochlorites, perborates, persulfates, peroxides (including organic peroxides), enzymes, derivatives thereof, and combinations thereof. Other suitable breakers may include suitable acids. Examples of peroxides that may be suitable include tert-butyl hydroperoxide and tert-amyl hydroperoxide. A breaker may be included in an acidic treatment fluid of this disclosure in an amount and form sufficient to achieve the desired viscosity reduction at a desired time. The breaker may be formulated to provide a delayed break, if desired. For example, a suitable breaker may be encapsulated if desired. Suitable encapsulation methods are known to those skilled in the art. One suitable encapsulation method that may be used involves coating the breaker(s) with a material that will degrade when placed downhole so as to release the breaker at the appropriate time. Coating materials that may be suitable include, but are not limited to, polymeric materials that will degrade when downhole. The terms “degrade,” “degradation,” or “degradable” refer to both the two relatively extreme cases of hydrolytic degradation that the degradable material may undergo, e.g., heterogeneous (or bulk erosion) and homogeneous (or surface erosion), and any stage of degradation in between these two. This degradation can be a result of, inter alia, a chemical or thermal reaction or a reaction induced by radiation. Suitable examples of materials that can undergo such degradation include polysaccharides such as dextran or cellulose; chitins; chitosans; proteins; aliphatic polyesters; poly (lactides); poly(glycolides); poly(E-caprolactones); poly(hydroxybutyrates); poly(anhydrides); aliphatic polycarbonates; orthoesters, poly(orthoesters); poly(amino acids); poly(ethylene oxides); polyphosphazenes; derivatives thereof; and combinations thereof. If used, a breaker can be included in a composition of this disclosure in an amount sufficient to facilitate the desired reduction in viscosity in a viscosified treatment fluid. For instance, peroxide concentrations that may be used vary from about 0.1 to about 10 gallons of peroxide per 1000 gallons of the acidic treatment fluid.

Optionally, an acidic treatment fluid of this disclosure may contain an activator or a retarder, inter alia, to optimize the rate at which the fluid is “broken” (e.g., the viscosity of the fluid is reduced). Any known activator or retarder that is compatible with the fluid and the components thereof is suitable for use in this disclosure. Examples of such activators that may be suitable include, but are not limited to, acid generating materials, chelated iron, copper, cobalt, reducing sugars, derivatives thereof, and combinations thereof. Examples of retarders that may be suitable include sodium thiosulfate and diethylene triamine. In embodiments, the sodium thiosulfate may be used in a range of from about 1 to about 100 lb per 1000 gallons of acidic treatment fluid. A concentration range can be from about 5 to about 20 lb per 1000 gallons. A person of ordinary skill with the benefit of this disclosure will be able to identify a suitable activator or retarder and the proper concentration of such activator or retarder for a given application.

The acidic treatment fluids of this disclosure also may comprise suitable fluid loss control agents. Such fluid loss control agents may be useful, among other instances, when an acidic treatment fluid of this disclosure is being used in a fracturing application. This may be due, in part, to the clarified xanthan's potential to leak off into formation. Any fluid loss agent that is compatible with the treatment fluid may be suitable for use in this disclosure. Examples include, but are not limited to, starches, silica flour, and diesel dispersed in a fluid. Other examples of fluid loss control additives that may be suitable are those that comprise a degradable material. Suitable degradable materials include degradable polymers. Specific examples of suitable polymers include polysaccharides such as dextran or cellulose; chitins; chitosans; proteins; aliphatic polyesters; poly(lactides); poly(glycolides); poly(glycolide-co-lactides); poly(E-caprolactones); poly(3-hydroxybutyrates); poly(3-hydroxybutyrateco-hydroxyvalerates); poly(anhydrides); aliphatic poly(carbonates); poly(orthoesters); poly(amino acids); poly(ethylene oxides); poly(phosphazenes); derivatives thereof; or combinations thereof. If included, a fluid loss additive can be added to an acidic treatment fluid of this disclosure in an amount of about 5 to about 2000 pounds per 1000 gallons of the acidic treatment fluid. In embodiments, the fluid loss additive may be included in an amount from about 1 to about 300, from about 1 to about 200, or from about 50 to about 200 pounds per 1000 gallons of the acidic treatment fluid. For some liquid additives like diesel, these may be included in an amount from about 0.01% to about 20% by volume; in embodiments, these may be included in an amount from about 1% to about 10% by volume.

Scale inhibitors optionally may be added to the acidic treatment fluids of this disclosure, for example, when an acidic treatment fluid of this disclosure is not particularly compatible with the formation waters in the formation in which it is being used. Any scale inhibitor that is compatible with the acidic treatment fluid in which it will be used may be suitable for use in this disclosure. This may include water soluble organic molecules with carboxylic acid, aspartic acid, maleic acids, sulphonic acids, N-phosphonoalkyl iminodiacetic acid, phosphonic acid and phosphate esters groups including copolymers, terpolymers, grafted copolymers, derivatives thereof, and combinations thereof. Examples of such compounds include aliphatic phosphonic acids such as diethylene triamine penta (methylene phosphonate) and polymeric species such as polyvinylsulphonate. The scale inhibitor may be in the form of the free acid, or may be in the form of mono- and polyvalent cation salts such as those comprising Na+, K+, Al+, Fe+, Ca+, Mg+, NH4+cations. An example of a suitable scale inhibitor is SCALECHECK® LP-55 Scale Inhibitor from Halliburton Energy Services in Duncan, OK. Another example of a suitable scale inhibitor is LP-65™ Scale Inhibitor available from Halliburton Energy Services in Duncan, OK. If used, a scale inhibitor can be included in an amount effective to inhibit scale formation. For some applications, suitable amounts of scale inhibitors that may be included in the treatment fluids of this disclosure may range from about 0.05 to 250 gallons, from about 1 to 200 gallons, or from about 10 to 200 gallons per about 1000 gallons of the treatment fluid.

Salts optionally may be included in the acidic treatment fluids of this disclosure for many purposes, including, as noted hereinabove, adjusting the density of the fluid. One of ordinary skill in the art with the benefit of this disclosure will recognize the particular type of salt appropriate for particular application, given considerations such as protection of the formation, the presence or absence of reactive clays in the formation adjacent to the wellbore, compatibility with the other acidic treatment fluid additives, and the factors affecting wellhead control. To determine whether a salt may be used, a compatibility test may be performed to identify potential compatibility problems. From such tests, one of ordinary skill in the art with the benefit of this disclosure will be able to determine whether a salt can be included in an acidic treatment fluid of this disclosure, as well as the appropriate selection of salts. Suitable salts may include, but are not limited to, calcium bromide, zinc bromide, calcium chloride, sodium chloride, sodium bromide, potassium bromide, potassium chloride, sodium nitrate, sodium formate, potassium formate, cesium formate, magnesium chloride, ammonium chloride, derivatives thereof, mixtures thereof, and the like.

The treatment fluids of this disclosure optionally may comprise a stabilizer, for example, if a chosen acidic treatment fluid of this disclosure is experiencing a viscosity degradation. One example of a situation where a stabilizer might be beneficial is where the borehole temperature of the wellbore is sufficient by itself to break the acidic treatment fluid. Suitable stabilizers may include, but are not limited to, sodium thiosulfate. Such stabilizers may be useful, for example, when the acidic treatment fluids of this disclosure are utilized in a subterranean formation having a temperature above about 150° F. If included, a stabilizer may be added in an amount from about 1 lb to about 50 lb per 1000 gal of acidic treatment fluid. In embodiments, a stabilizer may be included in an amount of from about 5 to about 20 lb per 1000 gal of acidic treatment fluid.

The treatment fluids of this disclosure optionally may comprise one or more particulates, for example to serve as a diverting material or diverting agent to aid in the placement of the treatment fluid into a desired region of the wellbore and/or surrounding formation. Particulates suitable for use in the methods of the present disclosure may be of any size and shape combination known in the art as suitable for use in fracturing operations. Particulates can be either rigid or deformable. Generally, where the chosen particulate is substantially spherical, suitable particulates have a size in the range of from about 2 to about 400 mesh, U.S. Sieve Series. In embodiments of the present disclosure, the particulates can have a size in the range of from about 4 to about 200 mesh, from about 8 to about 120 mesh, or from about 5 to about 200 mesh, U.S. Sieve Series.

In embodiments of the present disclosure, it may be desirable to use substantially non-spherical particulates. Suitable substantially non-spherical particulates may be cubic, polygonal, fibrous, or any other non-spherical shape. Such substantially non-spherical particulates may be, for example, cubic-shaped, rectangular-shaped, rod-shaped, ellipse-shaped, cone-shaped, pyramid-shaped, or cylinder-shaped. That is, in embodiments wherein the particulates are substantially non-spherical, the aspect ratio of the material may range such that the material is fibrous to such that it is cubic, octagonal, or any other configuration. Substantially non-spherical particulates are generally sized such that the longest axis is from about 0.02 inches to about 0.3 inches in length. In embodiments, the longest axis is from about 0.05 inches to about 0.2 inches in length. In one embodiment, the substantially non-spherical particulates are cylindrical having an aspect ratio of about 1. 5 to 1 and about 0.08 inches in diameter and about 0.12 inches in length. In embodiments, the substantially non-spherical particulates are cubic having sides about 0.08 inches in length. The use of substantially non-spherical particulates may be desirable in embodiments of the present disclosure because, among other things, they may provide a lower rate of settling when slurried into a fluid, as is often done to transport particulates to desired locations within subterranean formations. By so resisting settling, substantially non-spherical particulates may provide improved particulate distribution as compared to more spherical particulates. In poorly consolidated formations (that is, formations that, when assessed, fail to produce a core sample that can be satisfactorily drilled, cut, etc.) the use of substantially non-spherical particulates also may help to alleviate the embedment of particulates into the formation surfaces (such as a fracture face). As is known by one skilled in the art, when substantially spherical particulates are placed against a formation surface under stress, such as when they are used to prop a fracture, they are subject to point loading. By contrast, substantially non-spherical particulates may be able to provide a greater surface area against the formation surface and thus may be better able to distribute the load of the closing fracture.

Particulates used in the present disclosure can comprise any material suitable for use in subterranean applications. Suitable materials that may be used as particulates (e.g., proppant and/or gravel particulates) include, but are not limited to: sand; bauxite; ceramic materials; glass materials; polymer materials; Teflon® materials; nut shell pieces; seed shell pieces; fruit pit pieces; wood; composite particulates; light weight proppant; cured resinous particulates comprising nut shell pieces, seed shell pieces, inorganic fillers, and/or fruit pit pieces; and combinations thereof. Additionally, composite particulates may be utilized as proppant and/or gravel particulates. Such composites may include a binder and a filler material, wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof.

In embodiments, the acidic treatment fluid of this disclosure comprises at least one of the following: a hydrate inhibitor; a corrosion inhibitor; a pH control additive; a surfactant; a breaker; a fluid loss control additive; a scale inhibitor; an asphaltene inhibitor; a paraffin inhibitor; a foaming agent; a defoamer; an emulsifier; a demulsifier; an iron control agent; a solvent; a mutual solvent; a particulate diverter; a gas; carbon dioxide; nitrogen; a biopolymer other than a primary gelling agent (e.g., diutan); a synthetic polymer; a friction reducer; or a combination thereof.

In embodiments, the acidic treatment fluid comprises at least one of the following: fresh water; salt water; a brine; a salt; potassium chloride; sodium bromide; ammonium chloride; cesium formate; potassium formate; sodium formate; sodium nitrate; calcium bromide; zinc bromide; sodium chloride; hydrochloric acid; hydrofluoric acid; acetic acid; formic acid; citric acid; ethylene diamine tetraacetic acid; glycolic acid; or sulfamic acid.

In embodiments, the acidic treatment fluid comprises at least one of the following: a hydrate inhibitor; a corrosion inhibitor; a pH control additive; a surfactant; a breaker; a fluid loss control additive; a scale inhibitor; an asphaltene inhibitor; a paraffin inhibitor; a foaming agent; a defoamer; an emulsifier; a demulsifier; an iron control agent; a solvent; a mutual solvent; a particulate diverter; a gas; carbon dioxide; nitrogen; a biopolymer; a synthetic polymer; or a friction reducer.

In embodiments, the acidic treatment fluids of the present disclosure also may comprise suitable: hydrate inhibitor, corrosion inhibitors, pH control additives, surfactants, breakers, fluid loss control additives, scale inhibitors, asphaltene inhibitors, paraffin inhibitors, salts, foamers, defoamers, emulsifiers, demulsifiers, iron control agents, solvents, mutual solvents, particulate diverters, gas phase, carbon dioxide, nitrogen, other biopolymers, synthetic polymers, friction reducers combinations thereof, or the like. The acidic treatment fluids of the present disclosure also may include other additives that may be suitable for a given application.

In embodiments, the acidizing treatment fluid of tis disclosure comprises: an aqueous carrier fluid; an acid selected from the group consisting of hydrochloric acid, hydrobromic acid, formic acid, acetic acid, methanesulfonic acid, and any combination thereof, a gelling agent comprising diutan, and a foaming stabilizing agent comprising an antimony-containing compound. The treatment fluid can be a foamed treatment fluid produced by foaming the acidizing fluid.

In embodiments, a foamed acidizing fluid of this disclosure (e.g., for acidizing or fracture-acidizing subterranean zones) can comprise: an aqueous (e.g., hydrochloric) acid solution; sufficient (e.g., nitrogen) gas to form a foam; and an effective amount of a foaming stabilizing agent for foaming and stabilizing the aqueous acid solution, wherein the foaming and stabilizing agent comprises, consists essentially of, or consists of an antimony-containing compound. In embodiments, a foamed acidizing fluid of this disclosure for acidizing or fracture-acidizing subterranean zones comprises: an aqueous (e.g., hydrochloric) acid solution; a gelling agent (e.g., diutan, or a gelling agent comprised of a copolymer of about 5% to about 60% by weight acrylamide and the remainder selected from the group of dialkylaminoethylacrylate, trialkylaminoethylmethacrylate quaternary salt and acrylamido alkane sulfonic acid); sufficient (e.g., nitrogen) gas to form a foam; optionally a chemical foaming agent (e.g., a surfactant); and an amount of a foaming and stabilizing agent for foaming and stabilizing the aqueous acid solution, wherein the foaming and stabilizing agent comprises, consists essentially of, or consists of an antimony-containing compound.

As represented by Eq. 1, foam quality is the ratio of gas volume to foam volume (gas volume plus liquid volume) over a given pressure and temperature. Nitrogen or carbon dioxide or another gas can be used to create the foam in liquid status. Nitrogen can be desirable when water is present, as carbon dioxide can, in such applications, be harsh and eroding.

$$FQ = GV / ( GV + LV ) \qquad ( Eq . 1 )$$

where FQ is the foam quality, %; GV=gas volume (e.g., barrels (BBLs) or gallons); and LV=liquid volume (e.g., BBLs or gallons). In embodiments, when foamed, the acidizing fluid of this disclosure has a foam quality that is at least 20, 25, 30, 35, or 40%.

Foam stability can be expressed in terms of foam half-life or “half drain time”, which is the time required for half of the volume of liquid contained in the foam to revert to the bulk-liquid phase. The shorter the half drain time, the lower is the stability of the foam. The half drain time can be determined by the time required for one half of the liquid volume to drain from the generated foam. The acidizing fluid of this disclosure can exhibit an improvement in observed foam-stability (e.g., as determined by the half-drain time) greater than (e.g., between 50 to 15,000, or 300 to 15,000 times) that of conventional foaming formulations having the same composition but absent the foaming stabilizing agent disclosed herein. In embodiments, when foamed, the acidizing fluid has a stability, as determined by the half drain time, that is greater than the half drain time of a same acidizing fluid absent the foaming stabilizing agent comprising the antimony-containing compound. In embodiments, the acidizing fluid of this disclosure has a half-drain time that is at least 10, 50, 100, 150, 200, 300, 400, 500, 600, or 700 times a half drain time of a same acidizing fluid absent the foaming stabilizing agent comprising the antimony-containing compound.

The temperature of the subterranean formation into which the acidizing treatment fluid of this disclosure is introduced is not particularly limited. In embodiments, the acidizing fluids and methods of this disclosure can be suitable for use in wellbores comprising a borehole temperature (“BHT”) of up to about 500° F. In embodiments, the subterranean formation may have a temperature of about 100° F. or above, or about 150° F. or above, or about 200° F. or above, or about 250° F. or above, or about 300° F. or above. In embodiments, the subterranean formation may have a temperature of from about 100° F. to about 500° F., from about 100° F. to about 450° F., from about 100° F. to about 400° F. In embodiments, a temperature range is a treating temperature below about 250° F. One should note that the ability of the acidizing fluids of the present disclosure to maintain a degree of viscosity at such elevated temperatures may be affected by the time a particular fluid is exposed to such temperatures. For example, in some fracture acidizing applications, there may be a considerable fracture cool-down, which may enable utilization of an acidic treatment fluid of the present disclosure at BHT above the temperature limit at which the fluid demonstrates viscosity. One of the many advantages of the acidizing fluids of the present disclosure is that they may not leave undesirable residues in the formation once the fluid has been broken. Another advantage can be that the gelling agents utilized can be environmentally acceptable in some sensitive environments (such as the North Sea) and/or can be locally sourced. Additionally, the acidizing fluids of the present disclosure may present a cost savings over some conventional acidizing fluids for acidic treatment fluid applications. The acidic treatment fluids of the present disclosure may be useful in a wide variety of subterranean treatment operations in which acidic treatment fluids may be suitable.

As noted herein, the acidic treatment fluids of the present disclosure generally comprise an aqueous base fluid, an acid, a gelling agent, and a foaming stabilizing agent comprising an antimony-containing compound. When used in diversion applications, the treatment fluid may or may not comprise an acid. One of ordinary skill in the art with the benefit of this disclosure will be able to determine whether an acid is appropriate. Generally speaking, the acidizing fluids of the present disclosure have a pH of less than about 4. In embodiments, the treatment fluids of this disclosure may have a pH of about 4 or less. In embodiments (e.g., where the acid comprises hydrochloric acid), the treatment fluids may have a pH of about 1 or less. In embodiments (e.g., where the acid comprises an organic acid), the treatment fluids may have a pH of about 1 to about 4.

In embodiments, an acidic treatment fluid of this disclosure can be prepared by combining the components in any suitable order. In embodiments, an acidizing fluid of this disclosure can be prepared according to a process comprising: providing an aqueous base fluid having a suitable density; adding optional additives such as biocides, chelating agents, pH control agents, and the like; optionally filtering the aqueous base fluid (e.g., through a 2-μm (or finer) filter); dispersing the gelling agent and the foaming stabilizing agent into the aqueous base fluid with adequate shear to fully disperse the gelling agent therein; and mixing the treatment fluid until the gelling agent is fully hydrated. However, these methods may be varied in any manner appropriate for a particular application of this disclosure, as will be recognized by a person of skill in the art, with the benefit of this disclosure.

In embodiments, the foaming stabilizing agent can be dissolved in water to form an aqueous solution which can be added to an aqueous acid solution comprising the acid and the aqueous base fluid, and can be foamed along with a gas (and/or an agent that reacts or degrades thus creating a gas) for foaming the aqueous acid solution.

Furthermore, the acidic treatment fluids used in the methods of this disclosure (or any component thereof) may be provided “on-the-fly” (e.g., at a jobsite just prior to use, with or without a hydration tank) or by batch process (premixing). Additionally, the gelling agent(s) (e.g., polymers) of the acidizing fluid may be used as a dry powder, an liquid gel concentrate (LGC), a paste, or as a slurry.

Operations to extract a subterranean product from the earth through a well formed by a wellbore often use treatment fluids to facilitate or implement the operations. Hydrocarbons, such as oil and gas, are subterranean products commonly extracted from reservoirs, areas of the earth that contain the hydrocarbons. A reservoir may be deep below the surface of the earth and the earth may include one or more formations that are above and/or make up the reservoir. A formation is a region of the earth with a distinct lithology describing the physical characteristics of the rock in the formation, such as mineral content.

As noted herein, to help increase the productivity of a reservoir for hydrocarbons, stimulation techniques may be performed using treatment fluids such as stimulation fluids. For example, matrix acidizing and acid fracturing are two stimulation techniques used to increase production of hydrocarbons from a well by using acid present in respective matrix acidizing and acid fracturing fluids to dissolve rock. The dissolution of the rock creates or enlarges conductive pathways of permeability to the hydrocarbons in a subterranean formation to flow hydrocarbons from the subterranean formation to the earth's surface via the wellbore. The acidizing fluid of this disclosure can be utilized in such matrix acidizing and acid fracturing methods.

The choice of technique between matrix acidizing and acid fracturing tends to depend on the permeability and porosity of the subterranean formation. Unconventional hydraulic fracturing is the technique generally used for formations containing harder or very low permeability rock such as shale and tight sandstone. Acid fracturing is similar to unconventional fracturing in that it uses higher pressures and a reactive fluid for creating and enlarging fractures, microfractures, or other natural or generated flow paths. To create and enlarge the fractures or flow paths, acid fracturing relies on the heterogeneity of the rock leading to differential dissolution. Contrarily to hydraulic fracturing, acid fracturing typically does not include placing proppant in the created or enlarged fractures or flow paths. Although, acid fracturing is used for some formations containing softer rock such as carbonate rock, carbonate rock tends not to lend itself to the use of proppant.

Matrix acidizing is the technique generally used for formations containing softer, permeable rock such as carbonate rock. Matrix acidizing uses an acidizing treatment fluid, introduced at lower pressures that are below fracturing gradient, for creating and enlarging conductive flow paths. The resulting conductive flow paths may include narrow paths termed wormholes. The high solubility of and heterogeneous nature of carbonate rock in the acids used for matrix acidizing facilitates wormhole formation.

In embodiments, the treatment fluids and methods described herein can be utilized in matrix acidizing operations. That is, in embodiments, the treatment fluids described herein can be introduced to a subterranean formation below a fracture gradient pressure of the subterranean formation. In embodiments, the interaction of the treatment fluid with the formation matrix may result in the desirable formation (e.g., of wormholes) therein. In embodiments, the treatment fluids described herein can be introduced to a subterranean formation at or above a fracture gradient pressure of the subterranean formation, such that one or more fractures are created or enhanced in the subterranean formation. Given the benefit of the present disclosure and the understanding of one having ordinary skill in the art, one can readily determine whether to introduce the treatment fluids to a subterranean formation at matrix flow rates (e.g., below the fracture gradient pressure) or at fracturing flow rates (e.g., at or above the fracture gradient pressure).

A method of this disclosure can comprise: providing an acidizing fluid of this disclosure; and introducing the acidizing fluid into a wellbore penetrating a subterranean formation. The introducing of the acidizing fluid into the wellbore can be effected during a wellbore treatment operation selected from stimulating, diverting, rejuvenating, zonal coverage, or a combination thereof. In embodiments, the acidizing fluid has a pH of less than or equal to about 5.5, 5, 4, 3, 2, 1, 0, −1, −1.5, or −2.

The method can further comprise foaming the acidizing fluid to provide a foamed acidizing fluid by introducing a foaming agent (e.g., introducing a gas, shearing the acidizing fluid). The method can include foaming the acidizing fluid by introducing the acidizing fluid upstream of a pump, whereby the acidizing fluid is foamed via shear in the pump.

In embodiments, the acidizing fluid can be introduced into the wellbore as a matrix acidizing or fracture acidizing treatment. The method of this disclosure can include acidizing a portion of the subterranean formation by allowing the acidizing fluid to interact with a component of the subterranean formation so that at least a portion of the component is dissolved. The method of this disclosure can include diverting fluids in the subterranean formation by allowing at least a first portion of the acidic treatment fluid to penetrate into a portion of the subterranean formation so as to substantially divert a second portion of the acidic treatment fluid or another treatment fluid to another portion of the subterranean formation. In embodiments, the first portion of the acidizing fluid diverts the second portion of the acidizing fluid or the another treatment fluid to another portion of the subterranean formation by becoming a sufficiently rigid gel.

In embodiments, methods described herein can comprise: providing a treatment fluid comprising an aqueous carrier fluid, an acid, and a foaming stabilizing agent comprising an antimony-containing compound; and introducing the treatment fluid into a subterranean formation, whereby the acid reacts with a component in the formation and/or the wellbore.

In embodiments, the treatment fluid may be introduced to the subterranean formation below a fracture gradient of the subterranean formation. In embodiments, the treatment fluid may be introduced to the subterranean formation at a pressure at or above a fracture gradient of the subterranean formation.

In embodiments, methods described herein can comprise: providing a treatment fluid comprising an aqueous carrier fluid, an acid, and a foaming stabilizing fluid comprising an antimony-containing compound; and introducing the treatment fluid into a subterranean formation, the treatment fluid being introduced into the subterranean formation at a pressure greater than or equal to a fracture gradient of the subterranean formation, so as to form a fractured formation.

In embodiments, a method of acidizing a portion of a subterranean formation comprises: providing an acidic treatment fluid that comprises an aqueous base fluid, an acid, a gelling agent; and a foaming stabilizing agent comprising an antimony-containing compound; contacting a portion of the subterranean formation with the acidic treatment fluid; and allowing the acidic treatment fluid to interact with a component of the subterranean formation so that at least a portion of the component is dissolved.

Embodiments of this disclosure provide a method of diverting fluids in a subterranean formation. In an example of such a method, the method may comprise: providing an acidic treatment fluid comprising an aqueous base fluid, an acid, a gelling agent, and a foaming stabilizing agent; foaming the acidizing fluid; and introducing the acidic treatment fluid into a wellbore that penetrates the subterranean formation; and allowing at least a first portion of the acidic treatment fluid to penetrate into a portion of the subterranean formation so as to substantially divert a second portion of the acidic treatment fluid or another treatment fluid to another portion of the subterranean formation. In embodiments, the first portion of the acidic may divert the second portion of the acidic treatment fluid or another treatment fluid to another portion of the subterranean formation by becoming a sufficiently rigid gel to do so. These steps may be repeated as desired.

In subterranean applications such as wellbore cleanout, the objectives can be primarily focused on displacement of drilling fluids or other fluids occupying the wellbore and removal of drilling fluid residue and other contaminants occupying the wellbore. In this regard, a displacement fluid, sometimes called a spacer fluid, can be used. Oftentimes, coiled tubing may be used to place the displacement fluid in the wellbore. The displacement fluid may be a gelled treatment fluid. It is generally believed that the displacement fluid should be similar in density to the drilling or other fluid occupying the wellbore to prevent substantial commingling of these fluids during the displacement process. Additionally, the displacement fluid often contains an agent to aid in removing contaminants adhering to the wellbore walls as well as certain solids which may be loosely in residence in the wellbore. Often, this also results in the removal of wellbore-fill material, such as sand, scale, or organic materials, and other debris from the wellbore.

In many subterranean applications, it is desirable for a treatment fluid to inhibit the amount of leakage of the liquid phase of a treatment fluid into the formation matrix. Fluid loss control agents are often used to control the process and avoid potential reservoir damage. This is also thought to be helpful in some subterranean applications, it may be desirable to divert the flow of treatment fluids.

In other subterranean applications, it may be desirable to divert the flow of formation fluids, such as preventing the excessive production of formation brine. Since fluids may tend to follow the path of least resistance, fluid flow may be diverted for example, by invading the higher permeability portions of the formation with a fluid that has high viscosity at low shear rates. in maintaining fracture width and length.

In embodiments, a method of acidizing according to this disclosure comprises: providing an acidic treatment fluid that comprises an aqueous base fluid, an acid, a gelling agent, and a foaming stabilizing agent that comprises an antimony-containing compound; and introducing the acidic treatment fluid into a portion of a subterranean formation.

As noted herein, the acidizing fluids used in the methods of this disclosure (or any component thereof) may be provided “on-the-fly” (e.g., at a jobsite just prior to use, with or without a hydration tank) or by batch process (premixing). The gelling agents and/or other components can be provided as a dry powder, an liquid gel concentrate (LGC), a paste, or as a slurry.

In various embodiments, systems configured for delivering the treatment fluids described here into a downhole location are described. In embodiments, the systems can comprise a pump fluidly coupled to a tubular, the tubular containing a treatment fluid as described herein.

The pump may be a high pressure pump in embodiments. As used herein, the term “high pressure pump’ will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In embodiments, the high pressure pump may be capable of fluidly conveying particulate matter. Such as proppant particulates, into the subterranean formation. Suitable high pressure pumps will be known to one having ordinary skill in the art and may include, but are not limited to, floating piston pumps and positive displacement pumps.

In embodiments, the pump may be a low pressure pump. As used herein, the term “low pressure pump’ will refer to a pump that operates at a pressure of about 1000 psi or less. In embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up’ the pressure of the treatment fluid before it reaches the high pressure pump.

In embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole. The acidizing fluid can be foamed via passage through the low pressure pump, the high pressure pump, or both.

In embodiments, a system of this disclosure comprises: a pump fluidly coupled to a tubular, the tubular containing an acidizing fluid of this disclosure (e.g., a treatment fluid comprising an aqueous carrier fluid, an acid, a gelling agent, and a foaming stabilizing agent comprising an antimony-containing compound).

To facilitate a better understanding of the present disclosure, the following examples of embodiments are given. In no way should the following examples be read to limit, or define, the scope of the disclosure. Embodiments of the present disclosure involving wellbores may be applicable to horizontal, vertical, deviated, or otherwise nonlinear wellbores in any type of subterranean formation. Embodiments may be applicable to injection wells, monitoring wells, and production wells, including hydrocarbon or geothermal wells. Furthermore, storage wells where the permanent or temporary entrapment of industrial emissions containing gases such as carbon dioxide (CO₂) primarily, but also others such as nitrogen oxides (NOx) or sulfur oxides (SOx); or halogenated gases such as fluorocarbons, oxygenated fluorocarbons, or chlorocarbons or other organohalogenated small molecules (C1 to C5), may also be applicable.

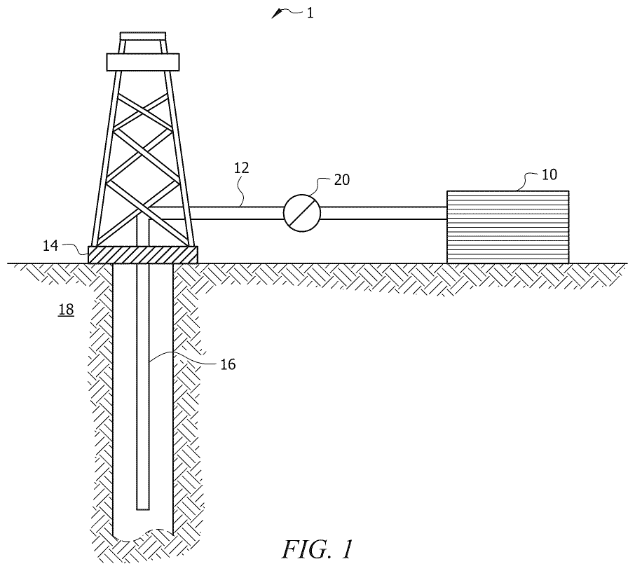

FIG. 1 shows an illustrative schematic of a system that can deliver treatment fluids of the present disclosure to a downhole location, according to one or more embodiments. It should be noted that while FIG. 1 generally depicts a land based system, it is to be recognized that like systems may be operated in subsea locations as well. As depicted in FIG. 1, system 1 may include mixing tank 10, in which a treatment fluid of the present disclosure may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in embodiments, flow back to wellhead 14 and exit subterranean formation 18. In embodiments, the treatment fluid that has flowed back to wellhead 14 may subsequently be recovered and recirculated to subterranean formation.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert Strings, drill String, coiled tubing, slickline, wireline, drill pipe, drill collars, mud motors, downhole motors and/or pumps, Surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

In various embodiments, the treatment fluids described herein may be used in conjunction with a stimulation operation conducted in a subterranean formation. The treatment fluids may be delivered downhole using the illustrative systems described hereinabove. In embodiments, the stimulation operation can comprise a fracturing operation. In embodiments, the stimulation operation can comprise an acidizing operation. In embodiments, the treatment fluids described herein may be used in conjunction with a remediation operation conducted in a subterranean formation.

In embodiments, the treatment fluids described herein may be used to treat a proppant pack or a gravel pack in a subterranean formation in order to increase its permeability. In embodiments, the treatment fluids may be used to treat an existing fracture in a subterranean formation in order to enhance a flow pathway therein. In embodiments, the treatment fluids may be used in the course of creating or extending a fracture in a subterranean formation by introducing the treatment fluid at or above a fracture gradient of the subterranean formation.

In embodiments, the treatment fluids may be used to remediate a subterranean formation that has precipitation or accumulation damage therein. As used herein, the term “precipitation or accumulation damage” refers to a material that has been dissolved in a subterranean formation and deposited elsewhere within the subterranean formation, optionally after undergoing a further reaction. That is, the treatment fluids described herein may be used to dissolve the various components of such damage in order to increase the permeability of the subterranean formation, thereby leading to the possibility of increased production. The precipitation or accumulation damage in the subterranean formation may result from any source, which may include another stimulation operation.

In embodiments, the treatment fluids described herein may be used in conjunction with drilling a wellbore penetrating a subterranean formation. For example, when used during drilling, the treatment fluids may desirably leave the subterranean formation conditioned with chelating agent so that precipitation can be subsequently mitigated at a later time. It is to be recognized, however, that the treatment fluids may also be used for proactive treatment of a subterranean formation at points in time other than in the drilling stage.

In embodiments, the present disclosure provides methods comprising: providing a treatment fluid of this disclosure (e.g., comprising an aqueous carrier fluid, an acid, a gelling agent, a foaming stabilizing agent, and optionally a foaming agent); and introducing the treatment fluid into a subterranean formation. The method can further include foaming the acidizing fluid prior to or during introducing the treatment fluid into the subterranean formation.

In embodiments, the present disclosure provides methods comprising: providing a treatment fluid comprising an aqueous base fluid, an acid, and a foaming stabilizing agent comprising an antimony-containing compound; and introducing the treatment fluid into a subterranean formation at a pressure greater than or equal to a fracture gradient of the subterranean formation, so as to form a fractured formation.

In embodiments, a method of this disclosure for acidizing or fracture acidizing a subterranean zone penetrated by a wellbore can comprise the following steps. A foamed acidizing fluid is prepared, wherein the foamed acidizing fluid comprises an aqueous acid solution, sufficient gas to form a foam and an effective amount of a foaming stabilizing agent for foaming and stabilizing the aqueous acid solution. The acidizing fluid can further include a gelling agent, a chemical foaming agent, or a combination thereof, as described herein. The method can further includes contacting the subterranean zone with the foamed acidizing fluid.

In embodiments, a method of acidizing or fracture-acidizing a subterranean zone penetrated by a wellbore comprises the steps of: (a) preparing a foamed acidizing fluid comprised of an aqueous (e.g., hydrochloric) acid solution, sufficient (e.g., nitrogen) gas to form a foam and an effective amount of a foaming and stabilizing agent for foaming and stabilizing the aqueous acid solution, wherein the foaming stabilizing agent comprises an antimony-containing compound; and (b) contacting the subterranean zone with the foamed acidizing fluid. The foamed acidizing fluid can further include a gelling agent, and/or a chemical foaming agent, such as a surfactant, as described herein.

To facilitate a better understanding of the present embodiments, the following examples of certain aspects of some embodiments are given. In no way should the following examples be read to limit, or define, the entire scope of the embodiments.

### Example

Experiments were conducted to analyze the foam stability and foam quality of aqueous acidizing fluids comprising various gelling agents and an acid corrosion inhibitor comprising propargyl based alcohol. The acid corrosion inhibitor can challenge the foam stability of conventional foamed acidizing fluids.

Gelling Agent A is a gelling agent comprising cationic acrylamide/dimethylaminoethyl methacrylate methychloride salt. Gelling Agent B is a gelling agent that comprises an AMPS polyacrylamide. Gelling Agent C is a gelling agent that comprises polyacrylamide. The suspension aid comprises a saccharide or diutan as noted in Table 1. The surfactant comprises alkyl amines and sodium chloride. The units for each component of the blend is provided in gallons of component per thousand gallons of the blend (GPT=gal/Mgal) or pounds of component per thousand gallons of the blend (PPT=lb/Mgal). The amount of water in the blend is dictated by whatever the remainder of the prepared blend is. The total concentration of all additives plus required volume of HCl to generate the desired final acid strength is subtracted from 1,000 gal to provide the necessary water volume. For the blends provided in Table 1, the blends were formulated to 15% HCl with 442 mL/L (mL/L=GPT) of 20° Be HCl.

The composition of each blend is set forth in Table 1. The foamed blends were prepared in a Waring blender. All additives were added to the blend sequentially with moderate stirring in order to disperse and homogenize the blend. After all additives had been included, the speed of the variable blender is slowly increased until a nominal value and allowed to stir for a set period of time to generate the foam. As seen in the results in Table 1, blends that exhibited inconsistent foam quality were dramatically improved with the inclusion of an antimony tetroxide foaming stabilizing agent of this disclosure.

TABLE 1
RESULTS^{a} OF FOAM STABILITY TESTING

| | Antimony | | | | | | |
|---|---|---|---|---|---|---|---|
| | Tetroxide | | Acid | | | | |
| | Foaming | | Corrosion | Gelling | | Foam | Half- |
| | Stabilizing | Suspension | Inhibitor, | Agent, | Surfactant, | Quality, | Drain |
| Blend | Agent, GPT | Aid, PPT | GPT | GPT | GPT | % | Time |

Gelling Agent A Blends

| | | | | | | | | |
|---|---|---|---|---|---|---|---|---|
| Blend A1 | — | — | 10 | Gelling | 15 | 40 | 2 | min |
| | | | | Agent A | | | | |
| | | | | (15) | | | | |
| Blend A2 | — | — | — | Gelling | 15 | 58 | 2 | min |
| | | | | Agent A | | | | |
| | | | | (15) | | | | |
| Blend A3, | 40 | 10 (diutan- | 10 | Gelling | 15 | 20 | >24 | h |
| w/Antimony | | based) | | Agent A | | | | |
| Tetroxide | | | | (15) | | | | |

Gelling Agent B Blends

| | | | | | | | | |
|---|---|---|---|---|---|---|---|---|
| Blend B1 | — | — | 10 | Gelling | 15 | 38 | 2 | min |
| | | | | Agent B | | | | |
| | | | | (15) | | | | |
| Blend B2 | — | 10 (saccharide- | 10 | Gelling | 15 | 33 | 1 | min |
| | | based) | | Agent B | | | | |
| | | | | (15) | | | | |
| Blend B3, | 40 | 10 (diutan- | 10 | Gelling | 15 | 39 | ~25 | min* |
| w/Antimony | | based) | | Agent B | | | | |
| Tetroxide | | | | (15) | | | | |

Gelling Agent C Blends

| | | | | | | | | |
|---|---|---|---|---|---|---|---|---|
| Blend C1 | — | — | 10 | Gelling | 15 | 55 | 4 | min |
| | | | | Agent C | | | | |
| | | | | (15) | | | | |
| Blend C2 | — | 10 (diutan- | 10 | Gelling | 15 | 52 | 4 | min |
| | | based) | | Agent C | | | | |
| | | | | (15) | | | | |
| Blend C3, | 40 | 10 (diutan- | 10 | Gelling | 15 | 53 | ~10 | h |
| w/Antimony | | based) | | Agent C | | | | |
| Tetroxide | | | | (15) | | | | |

No Gelling Agent Blend

| | | | | | | | | |
|---|---|---|---|---|---|---|---|---|
| Diutan Blend | 40 | 10 (diutan- | 10 | 0 | 15 | 38 | 3 | min |
| w/Antimony | | baased) | | | | | | |
| Tetroxide | | | | | | | | |

^{a}In all cases, regardless of gelling agent, the inclusion of the antimony tetroxide foaming stabilizing agent significantly increased foam stability. In the final case, the formulation demonstrates that diutan plus antimony tetraoxide alone was not sufficient to generate increased foam stability.

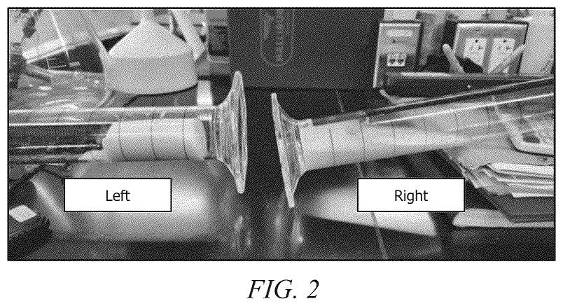

Foamed blends without the antimony tetroxide foaming stabilizing agent exhibited a water-like consistency that does not maintain shape. FIG. 2 shows a picture of a beaker containing a foamed acidizing fluid of this disclosure on the left, and a beaker containing a comparative acidizing fluid absent the foaming stabilizing agent on the right. As seen in FIG. 2, the stabilized foams comprising foam stabilizing agent of this disclosure exhibited a stable semi-rigid structure that maintains its shape outside of a container. On the left of FIG. 2, the foam rigidity of a stabilized foamed acidizing fluid of this disclosure comprising the foam stabilizing agent comprising antimony tetroxide is demonstrated, while the lack of rigidity of a conventional foamed acidizing fluid formulation absent the foam stabilizing agent of this disclosure is demonstrated on the right (e.g., the acidizing fluid of this disclosure on the left of FIG. 2 exhibits foam rigidity, while the conventional formulation on the right of FIG. 2 does not (e.g., is not rigid)).

A qualitative ease of mixing was also observed with the acidizing fluid blends of this disclosure. The antimony tetroxide-stabilized foam was quicker to achieve typical foam properties in the blender with less shear.

This Example illustrates how the acidizing fluid of this disclosure, stabilized with foam stabilizing agent (e.g., antimony tetroxide or another antimony-containing compound), can be generated with products that are currently not considered for acidizing foaming applications. Generating a stable foamed acid from acidizing and non-acidizing gelling agents can allow for greater regional adoption and ease of adjusting blends based on regional chemical availability.

On lab scale, foam generation can be an inconsistent process, but the inclusion of the foaming stabilizing agent of this disclosure into the formulations tested provided a distinct and readily perceivable improvement towards both the resultant foam properties (e.g., rigid) as well as ease of generating the foamed fluid. The foamed formulations that included the herein disclosed foaming stabilizing agent were quicker to achieve physical characteristics typical of foamed fluids and did so with less shear than blends that did not include the foaming stabilizing agent (e.g., antimony tetroxide).

In visual comparison of blends containing the foaming stabilizing agent (e.g., antimony tetroxide) there was a distinct and clearly perceivable difference in viscosity and rigidity of the foam. This could be beneficial for diversion and other acidizing applications; the visual inspection of the foamed fluid containing the foaming stabilizing agent of this disclosure showed increased viscosity that could be employed in a variety of formation characteristics (e.g., to provide viscous plugs in vulgarity/natural fractures of the formation). Thin viscosity foams, such as those excluding the foaming stabilizing agent of this disclosure, are less effective as a diverting material/fluid due to reduced viscosities and/or other physical properties (e.g., lack of rigidity or viscosity does not provide diversion characteristics or function within the formation). The acidizing fluid of this disclosure can thus unexpectedly provide improved foam rigidity and viscosity that aids in the overall usefulness and performance of the composition downhole.

Herein disclosed are an acidizing fluid and methods of making and using same. This disclosure provides improved foamed acidizing fluids and placement, enabling greater acid pump times and/or reduced gelling and/or foaming agent incompatibilities.

Current foam systems commonly have half-drain times (e.g., about ten minutes) that are less than acidizing pump times (e.g., about five hours). Providing a foamed acid system, as described herein, that is capable of multi-hour stability can eliminate concern about premature foam collapse.

The acidizing fluid of this disclosure can provide improved foam stability, improved additive compatibility, improved diversion, improved supply chain logistics, or a combination thereof.

The acidizing fluid of this disclosure provides for the available use of a larger portfolio of polymers for foamed fluids, thus allowing for wider regional adoption, with reduced concern for region-specific product availability. The acidizing fluid and methods of using same disclosed herein can be suitable for use in regions that may have complications procuring/securing additives commonly used in foaming applications.

Embodiments of the acidizing fluid of the present disclosure can improve acidizing performance, for example as determined by pore volume to breakthrough measurements, in comparison to reference compositions absent the foaming stabilizing agent comprising the antimony-containing compound.

### ADDITIONAL DISCLOSURE

The following are non-limiting, specific embodiments in accordance with the present disclosure:

In a first embodiment, an acidizing fluid (e.g., for matrix acidizing or fracture-acidizing a subterranean zone, the acidizing treatment fluid) comprises: an acid; an aqueous base fluid; a gelling agent; and a foaming stabilizing agent, wherein the foaming stabilizing agent comprises an antimony-containing compound.

A second embodiment can include the acidizing fluid of the first embodiment comprising from about 2.5 to about 37, from about 5 to about 35 or from about 1 to about 35 weight percent (wt %) of the acid; from about 0.5 to about 98, from about 1 to about 90, or from about 5 to about 85 wt % of the aqueous base fluid; from about 0.1 to about 10, from about 0.5 to about 10, or from about 1 to about 5 weight percent (wt %) of the gelling agent; and from about 0.1 to about 10, from about 0.5 to about 10, or from about 0.5 to about 8 wt % of the foaming stabilizing agent.

A third embodiment can include the acidizing fluid of the first or the second embodiment, wherein the acid is selected from hydrochloric acid, hydrofluoric acid, acetic acid, formic acid, glycolic acid, citric acid, ethylene diamine tetra acetic acid (EDTA), N-phosphonomethyl iminodiacetic acid (PMIDA), sulfamic acid, derivatives thereof, or a combination thereof.

A fourth embodiment can include the acidizing fluid of the third embodiment, wherein the acid comprises hydrochloric acid.

A fifth embodiment can include the acidizing fluid of any one of the first to fourth embodiments, wherein an aqueous solution comprising the acid and the aqueous base fluid comprises a concentration of the acid in a range of from about 2.5% to about 37% by weight of the aqueous acid solution.

A sixth embodiment can include the acidizing fluid of any one of the first to fifth embodiments, wherein the gelling agent is selected from biopolymers (e.g., xanthan, succinoglycan, and diutan), clarified biopolymers (e.g., clarified xanthan, clarified diutan, clarified scleroglucan), saccharides (e.g., cellulose, cellulose derivatives (e.g., hydroxy ethyl cellulose, carboxyalkyl cellulose, carboxyalkyl hydroxyalkyl cellulose, hydroxypropyl cellulose), guar, and guar derivatives (e.g., hydroxypropyl guar, hydroxylalkyl guar, carboxyalkyl hydroxyalkyl guar, carboxymethyl guar)), synthetic polymers (e.g., polyacrylamide, polyacrylate, polyacrylamide copolymers, and polyacrylate copolymers), or a combination thereof.

A seventh embodiment can include the acidizing fluid of any one of the first to sixth embodiments, wherein the gelling agent comprises diutan.

An eighth embodiment can include the acidizing fluid of any one of the first to seventh embodiments further comprising a foaming agent.

A ninth embodiment can include the acidizing fluid of the eighth embodiment, wherein the foaming agent comprises a physical foaming agent (e.g., a gas such as an inert gas), a gas generating compound, a chemical foaming agent, a surfactant, or any combination thereof.

A tenth embodiment can include the acidizing fluid of the ninth embodiment, wherein the foaming agent comprises a gas selected from air, carbon dioxide, nitrogen, a hydrocarbon, or a combination thereof.

An eleventh embodiment can include the acidizing fluid of the tenth embodiment comprising from about 10 to about 90, about 20 to about 80, or about 10 to about 80% by volume of the gas by weight of an aqueous solution comprising the acid and the aqueous fluid.

A twelfth embodiment can include the acidizing fluid of any one of the ninth to eleventh embodiments comprising the surfactant, wherein the surfactant is selected from ethoxylated nonyl phenol phosphate esters, nonionic surfactants, cationic surfactants, anionic surfactants, amphoteric/zwitterionic surfactants, alkyl phosphonate surfactants, linear alcohols, nonylphenol compounds, alkyoxylated fatty acids, alkylphenol alkoxylates, ethoxylated amides, ethoxylated alkyl amines, betaines, methyl ester sulfonates, hydrolyzed keratin, sulfosuccinates, taurates, amine oxides, alkoxylated fatty acids, alkoxylated alcohols, ethoxylated fatty amines, ethoxylated alkyl amines, betaines, modified betaines, alkylamidobetaines, quaternary ammonium compounds, derivatives thereof, or mixtures thereof.

A thirteenth embodiment can include the acidizing fluid of any one of the first to twelfth embodiments, wherein the antimony-containing compound is selected from antimonate salts, antimony oxides, antimony halides, antimony tartrate, antimony citrate, alkali metal salts of antimony tartrate and antimony citrate, alkali metal salts of pyroantimonate and antimony adducts of ethylene glycol, or combinations thereof.

A fourteenth embodiment can include the acidizing fluid of the thirteenth embodiment, wherein the antimony-containing compound comprises antimony tetroxide, antimony trichloride, or a combination thereof.

A fifteenth embodiment can include the acidizing fluid of any one of the first to fourteenth embodiments, wherein the aqueous fluid comprises fresh water, salt water, or a brine (e.g., a saturated salt water).

A sixteenth embodiment can include the acidizing fluid of any one of the first to fifteenth embodiments that has been foamed to provide a foamed acidizing fluid.

A seventeenth embodiment can include the acidizing fluid of the sixteenth embodiment, wherein the foamed acidizing fluid has a stability, as determined by the half drain time, that is (e.g., at least 300 times) greater than the half drain time of a same acidizing fluid absent the foaming stabilizing agent.

An eighteenth embodiment can include the acidizing fluid of the sixteenth or seventeenth embodiment, wherein the foamed acidizing fluid has a foam quality that is at least 20, 25, 30, 35, or 40%, wherein the foam quality is determined by: FQ=GV/(GV+LV), where FQ is the foam quality, %; GV=gas volume; and LV=liquid volume.

In a nineteenth embodiment, a method comprises: providing an acidizing fluid; and introducing the acidizing fluid into a wellbore penetrating a subterranean formation, wherein the acidizing fluid comprises: an acid; an aqueous base fluid; a gelling agent; and a foaming stabilizing agent, wherein the foaming stabilizing agent comprises an antimony-containing compound.

A twentieth embodiment can include the method of the nineteenth embodiment, wherein the introducing of the acidizing fluid into the wellbore is effected during a wellbore treatment operation selected from stimulating, diverting, rejuvenating, zonal coverage, or a combination thereof.

A twenty first embodiment can include the method of the nineteenth or twentieth embodiment, wherein the acidizing fluid has a pH of less than or equal to about 5.5, 5, 4, 2, 1, −1, −1.5, or −2.

A twenty second embodiment can include the method of any one of the nineteenth to twenty first embodiments further comprising foaming the acidizing fluid by introducing a gaseous foaming agent and/or shearing.

A twenty third embodiment can include the method of the twenty second embodiment further comprising introducing the acidizing fluid upstream of a pump, whereby the acidizing fluid is foamed via shear in the pump.

A twenty fourth embodiment can include the method of any one of the nineteenth to twenty third embodiments, wherein the acidizing fluid is introduced into the wellbore as a matrix acidizing or fracture acidizing treatment.

A twenty fifth embodiment can include the method of any one of the nineteenth to twenty fifth embodiments comprising acidizing a portion of the subterranean formation by allowing the acidizing fluid to interact with a component of the subterranean formation so that at least a portion of the component is dissolved.

A twenty sixth embodiment can include the method of any one of the nineteenth to twenty fifth embodiments, comprising diverting fluids in the subterranean formation by allowing at least a first portion of the acidic treatment fluid to penetrate into a portion of the subterranean formation so as to substantially divert a second portion of the acidic treatment fluid or another treatment fluid to another portion of the subterranean formation.

A twenty seventh embodiment can include the method of the twenty sixth embodiment, wherein the first portion of the acidizing fluid diverts the second portion of the acidizing fluid or the another treatment fluid to another portion of the subterranean formation by becoming a sufficiently rigid gel.

In a twenty eighth embodiment, an acidizing fluid comprises: from about 2.5 to about 37 weight percent (wt %) of an acid; from about 0.5 to about 98 wt % of a gelling agent; from about 0.1 to about 10 wt % of a foaming agent; from about 0.1 to about 10 wt % of a foaming stabilizing agent comprising an antimony-containing compound; and the balance an aqueous fluid.

A twenty ninth embodiment can include the acidizing fluid of the twenty eighth embodiment foamed with a gas and comprising from about 10 to about 90 wt % of the gas.

A thirtieth embodiment can include the acidizing fluid of the twenty eighth or twenty ninth embodiment having a half-drain time that is (e.g., at least 10, 50, 100, 150, 200, 300, 400, 500, 600, or 700 times) greater than a half drain time of a same acidizing fluid absent the foaming stabilizing agent.

A thirty first embodiment can include the acidizing fluid of any one of the twenty eighth to thirtieth embodiments, wherein the gelling agent comprises a saccharide-based gelling agent, an acrylamide-based gelling agent, a biopolymer-based gelling agent, or a combination thereof.

A thirty second embodiment can include the acidizing fluid of the thirty first embodiment, wherein the foaming agent comprises a surfactant selected from ethoxylated nonyl phenol phosphate esters, nonionic surfactants, cationic surfactants, anionic surfactants, amphoteric/zwitterionic surfactants, alkyl phosphonate surfactants, linear alcohols, nonylphenol compounds, alkyoxylated fatty acids, alkylphenol alkoxylates, ethoxylated amides, ethoxylated alkyl amines, betaines, methyl ester sulfonates, hydrolyzed keratin, sulfosuccinates, taurates, amine oxides, alkoxylated fatty acids, alkoxylated alcohols, ethoxylated fatty amines, ethoxylated alkyl amines, betaines, modified betaines, alkylamidobetaines, quaternary ammonium compounds, derivatives thereof, or mixtures thereof.

A thirty third embodiment can include the acidizing fluid of any one of twenty eighth to the thirty second embodiments, wherein the antimony-containing compound is selected from antimonate salts, antimony oxides, antimony halides, antimony tartrate, antimony citrate, alkali metal salts of antimony tartrate and antimony citrate, alkali metal salts of pyroantimonate and antimony adducts of ethylene glycol, or combinations thereof.

A thirty fourth embodiment can include the acidizing fluid of the thirty second or thirty third embodiment, wherein the antimony-containing compound comprises antimony tetroxide, antimony trichloride, or a combination thereof.

A thirty fifth embodiment can include the acidizing fluid of any one of the first to thirty fourth embodiments, wherein the acidizing fluid further comprises a diverting material/agent (e.g., a material to aid in plugging or otherwise diverting flow of the acidizing fluid during placement thereof into the wellbore and/or formation), for example, without limitation, a particulate material (e.g., a solid particulate material) designed to pack-off or plug a portion of the wellbore and/or surrounding formation to divert the acidizing fluid into another/different area during placement thereof.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R1, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. An acidizing fluid comprising:
an acid;
an aqueous base fluid;
a foaming agent comprising a surfactant;
one or more gelling agents, wherein the one or more gelling agents in the acidizing fluid consist of succinoglycan, clarified succinoglycan, diutan, clarified diutan, scleroglucan, clarified scleroglucan, cellulose, cellulose derivatives, guar, guar derivatives, saccharides, synthetic polymers, or a combination thereof, and
from 0.1 to 10 wt % of a foaming stabilizing agent, wherein the foaming stabilizing agent comprises an antimony-containing compound,
wherein the acidizing fluid, when foamed, has a stability, as determined by the half drain time, that is greater than the stability, as determined by the half drain time, of an otherwise same foamed acidizing fluid absent the foaming stabilizing agent.

2. The acidizing fluid of claim 1, comprising from 2.5 to 37 weight percent (wt %) of the acid; from 0.5 to 98 wt % of the aqueous base fluid; from 0.1 to 10 wt % of the gelling agent; and from 0.1 to 10 wt % of the foaming agent.

3. The acidizing fluid of claim 1, wherein the synthetic polymers are selected from the group consisting of polyacrylamide, polyacrylate, polyacrylamide copolymers, polyacrylate copolymers, and combinations thereof, wherein the cellulose derivatives are selected from the group consisting of hydroxy ethyl cellulose, carboxyalkyl cellulose, carboxyalkyl hydroxyalkyl cellulose, hydroxypropyl cellulose, and combinations thereof, wherein the guar derivatives are selected from the group consisting of hydroxypropyl guar, hydroxylalkyl guar, carboxyalkyl hydroxyalkyl guar, carboxymethyl guar, and combinations thereof, or a combination thereof.

4. (canceled)

5. The acidizing fluid of claim 1, wherein the foaming agent further comprises a gas, a gas generating compound, or a combination thereof.

6. The acidizing fluid of claim 1, wherein the antimony-containing compound is selected from the group consisting of antimonate salts, antimony oxides, antimony halides, antimony tartrate, antimony citrate, alkali metal salts of antimony tartrate and antimony citrate, alkali metal salts of pyroantimonate, antimony adducts of ethylene glycol, and combinations thereof.

7. The acidizing fluid of claim 1, wherein the antimony-containing compound comprises antimony tetroxide, antimony trichloride, or a combination thereof.

8. The acidizing fluid of claim 1 that has been foamed to provide a foamed acidizing fluid.

9. (canceled)

10. The acidizing fluid of claim 8, wherein the foamed acidizing fluid has a foam quality that is at least 20% and less than 100%, wherein the foam quality is determined by:
$$FQ = GV / ( GV + LV )$$
where FQ is the foam quality, %; GV=gas volume; and LV=liquid volume.

11. A method comprising:
providing foamed acidizing fluid; and
introducing the foamed acidizing fluid into a wellbore penetrating a subterranean formation,
wherein the foamed acidizing fluid comprises:
an acid;
a foaming agent;
an aqueous base fluid;
one or more gelling agents, wherein the one or more gelling agents in the foamed acidizing fluid consist of succinoglycan, clarified succinoglycan, diutan, clarified diutan, scleroglucan, clarified scleroglucan, cellulose, cellulose derivatives, guar, guar derivatives, saccharides, synthetic polymers, or a combination thereof, and
from 0.1 to 10 wt % of a foaming stabilizing agent, wherein the foaming stabilizing agent comprises an antimony-containing compound,
wherein the foamed acidizing fluid has a stability, as determined by the half drain time, that is greater than the half drain time of an otherwise same foamed acidizing fluid absent the foaming stabilizing agent.

12-13. (canceled)

14. The method of claim 11 comprising diverting fluids in the subterranean formation by allowing at least a first portion of the acidic treatment fluid to penetrate into a portion of the subterranean formation so as to substantially divert a second portion of the acidic treatment fluid or another treatment fluid to another portion of the subterranean formation.

15. The acidizing fluid of claim 3, comprising:
from about 2.5 to about 37 weight percent (wt %) of the acid;
from about 0.1 to about 10 wt % of the one or more gelling agents;
from about 0.1 to about 10 wt % of the foaming agent;
and
a balance the aqueous fluid.

16. The acidizing fluid of claim 15 foamed with a gas and comprising from about 10 to about 90 wt % of the gas.

17. (canceled)

18. The acidizing fluid of claim 15, wherein the gelling agent comprises a saccharide-based gelling agent, an acrylamide-based gelling agent, or a combination thereof.

19. The acidizing fluid of claim 15, wherein the antimony-containing compound is selected from the group consisting of antimonate salts, antimony oxides, antimony halides, antimony tartrate, antimony citrate, alkali metal salts of antimony tartrate and antimony citrate, alkali metal salts of pyroantimonate, antimony adducts of ethylene glycol, and combinations thereof.

20. The acidizing fluid of claim 15, wherein the antimony-containing compound comprises antimony tetroxide, antimony trichloride, or a combination thereof.

21. The acidizing fluid of claim 15, wherein the antimony-containing compound comprises antimony tetroxide.

22. The acidizing fluid of claim 20, wherein the gelling agent comprises a saccharide-based gelling agent, an acrylamide-based gelling agent, or a combination thereof.

23. The acidizing fluid of claim 1, further comprising an acid corrosion inhibitor.

24. The acidizing fluid of claim 1, wherein the antimony-containing compound comprises antimony tetroxide.

25. The acidizing fluid of claim 24, further comprising an acid corrosion inhibitor comprising a propargyl based alcohol.

26. The acidizing fluid of claim 1, wherein the acidizing fluid does not comprise xanthan.
